(19) United States
(12) Patent Application Publication
(10) Pub. No.: US 2025/0278045 A1
(43) Pub. Date: Sep. 4, 2025

(54) IMAGE FORMING APPARATUS

(71) Applicant: CANON KABUSHIKI KAISHA, Tokyo (JP)

(72) Inventors: AI SUZUKI, Singapore (SG); SHINGO ITO, Tokyo (JP); KAZUMICHI SHIMIZU, Chiba (JP)

(21) Appl. No.: 19/065,606

(22) Filed: Feb. 27, 2025

(30) Foreign Application Priority Data
Feb. 29, 2024 (JP) 2024-029873

(51) Int. Cl. G03G 15/00; G03G 15/08; G03G 15/16; G03G 15/20; G03G 21/16

(52) U.S. Cl. CPC G03G 15/5008; G03G 15/0808; G03G 15/1615; G03G 15/2064; G03G 15/5016; G03G 15/757; G03G 21/1638

(57) ABSTRACT

An image forming apparatus includes an image bearing member configured to rotate, a unit capable of taking a first state in which a part of a surface of the image bearing member is allowed to be exposed to an outside of the image forming apparatus, and a second state in which the surface of the image bearing member is not exposed to the outside of the image forming apparatus, a drive source configured to drive the image bearing member, and a control unit configured to control the drive source, the control unit being configured to execute a mode in which the image bearing member is rotated by the drive source while the unit is in the first state.

### BACKGROUND OF THE INVENTION

### Field of the Invention

The present invention relates to an image forming apparatus that forms an image on a recording material.

### Description of the Related Art

In an image forming apparatus in an electrophotographic system, in a case where an opening/closing member on an outer surface of the apparatus is opened for replacement of a cartridge or jam clearance, sebum may adhere to a surface of a photosensitive drum when a user's finger touches the surface or surrounding dust or dirt may adhere to the surface of the photosensitive drum. When soiling adheres to the surface of the photosensitive drum, toner is deposited on the soiling adhering portion, and an image defect may occur.

Japanese Patent Application Publication No. JP 2000-155447 A describes that a photosensitive drum and an intermediate transfer belt are idled and rotated in a state where peripheral speeds of the photosensitive drum and the intermediate transfer belt are different from each other, and the photosensitive drum and the intermediate transfer belt are polished to remove foreign matters.

### SUMMARY OF THE INVENTION

The present invention provides an image forming apparatus in which soiling on a surface of an image bearing member can be easily checked.

According to an aspect of the invention, an image forming apparatus includes an image bearing member configured to rotate, a unit capable of taking a first state in which a part of a surface of the image bearing member is allowed to be exposed to an outside of the image forming apparatus, and a second state in which the surface of the image bearing member is not exposed to the outside of the image forming apparatus, a drive source configured to drive the image bearing member, and a control unit configured to control the drive source, the control unit being configured to execute a mode in which the image bearing member is rotated by the drive source while the unit is in the first state.

Further features of the present invention will become apparent from the following description of exemplary embodiments with reference to the attached drawings.

### BRIEF DESCRIPTION OF THE DRAWINGS

FIG. 1 is a perspective view of an image forming apparatus according to a first embodiment.

FIG. 2 is a schematic view of the image forming apparatus according to the first embodiment.

FIG. 3 is a block diagram related to a circuit board according to the first embodiment.

FIG. 4A is an explanatory view of a back cover and a transfer unit according to the first embodiment.

FIG. 4B is an explanatory view of the back cover and the transfer unit according to the first embodiment.

FIG. 4C is an explanatory view of the back cover and the transfer unit according to the first embodiment.

FIG. 5A is an explanatory view of the back cover and the transfer unit according to the first embodiment.

FIG. 5B is an explanatory view of the back cover and the transfer unit according to the first embodiment.

FIG. 5C is an explanatory view of the back cover and the transfer unit according to the first embodiment.

FIG. 5D is an explanatory view of the back cover and the transfer unit according to the first embodiment.

FIG. 6A is an explanatory view regarding attachment and detachment of a process unit according to the first embodiment.

FIG. 6B is an explanatory view regarding attachment and detachment of the process unit according to the first embodiment.

FIG. 6C is an explanatory view regarding attachment and detachment of the process unit according to the first embodiment.

FIG. 6D is an explanatory view regarding attachment and detachment of the process unit according to the first embodiment.

FIG. 7A is an explanatory view regarding attachment and detachment of the process unit according to the first embodiment.

FIG. 7B is an explanatory view regarding attachment and detachment of the process unit according to the first embodiment.

FIG. 7C is an explanatory view regarding attachment and detachment of the process unit according to the first embodiment.

FIG. 7D is an explanatory view regarding attachment and detachment of the process unit according to the first embodiment.

FIG. 8A is an explanatory view of soiling and a toner lump on the photosensitive drum.

FIG. 8B is an explanatory view of soiling and a toner lump on the photosensitive drum.

FIG. 8C is an explanatory view of soiling and a toner lump on the photosensitive drum.

FIG. 9A is an explanatory view of white spots and missing characters.

FIG. 9B is an explanatory view of white spots and missing characters.

FIG. 10 is a sequence diagram of a manual drive mode according to the first embodiment.

FIG. 11 is a sequence diagram of a manual drive mode according to a second embodiment.

FIG. 12A is a diagram illustrating a relationship between a surface potential of a photosensitive drum and a potential of a process member according to a third embodiment.

FIG. 12B is a diagram illustrating a relationship between a surface potential of the photosensitive drum and a potential of the process member according to the third embodiment.

FIG. 13 is a schematic view of an image forming apparatus according to a fourth embodiment.

FIG. 14A is a diagram illustrating a relationship between a surface potential of a photosensitive drum and a potential of a process member according to the fourth embodiment.

FIG. 14B is a diagram illustrating a relationship between a surface potential of the photosensitive drum and a potential of the process member according to the fourth embodiment.

FIG. 15 is a schematic view of an image forming apparatus according to another embodiment.

### DESCRIPTION OF THE EMBODIMENTS

Hereinafter, embodiments according to the present disclosure will be described with reference to the drawings.

### First Embodiment

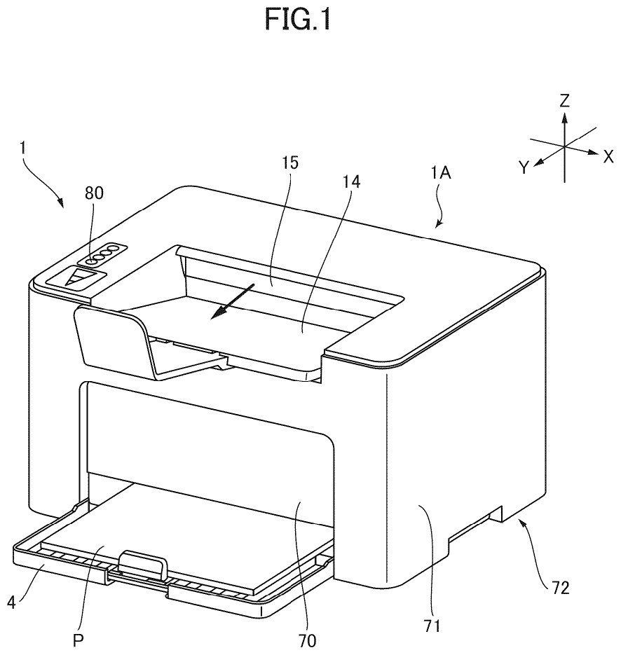

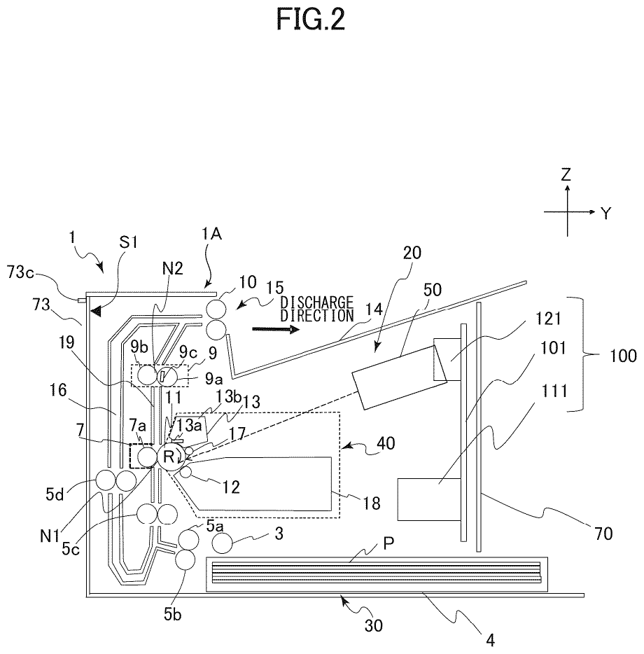

FIG. 1 is a perspective view illustrating an image forming apparatus 1 according to a first embodiment. FIG. 2 is a cross-sectional view of the image forming apparatus 1. The image forming apparatus 1 is a monochrome printer that forms an image on a recording material on the basis of image information input from an external device. The recording material includes various sheet materials having different material properties such as paper including plain paper and thick paper, a plastic film including a sheet for an overhead projector, a sheet having a special shape such as an envelope or index paper, and cloth.

As illustrated in FIGS. 1 and 2, the image forming apparatus 1 includes an image forming unit 20 that forms a toner image on the recording material, a feeding unit 30 that feeds a recording material P, a fixing unit 9 that fixes the toner image formed by the image forming unit 20 to the recording material, and a sheet discharge roller pair 10.

The image forming unit 20 includes a scanner unit 50, a process unit 40 in an electrophotographic system, and a transfer unit 7 including a transfer roller 7a serving as a transfer member. The process unit 40 includes a photosensitive drum 11 and one or more process portions disposed around the photosensitive drum 11. In the present embodiment, the process portion arranged in the process unit 40 includes a cleaning unit 13, a charging roller 17, and a developing unit including a developing roller 12 and a toner storage 18.

A portion obtained by removing the process unit 40 from the image forming apparatus 1 is referred to as an apparatus body 1A (image forming apparatus body). The process unit 40 is attachable/detachable to/from the apparatus body 1A.

The photosensitive drum 11 functions as an image bearing member of the present embodiment that bears a toner image. The photosensitive drum 11 is formed by forming a photosensitive material layer such as OPC (organic photosemiconductor), amorphous selenium, or amorphous silicon as a negatively chargeable photosensitive layer on a drum-shaped base formed of aluminum having a diameter of 24 mm.

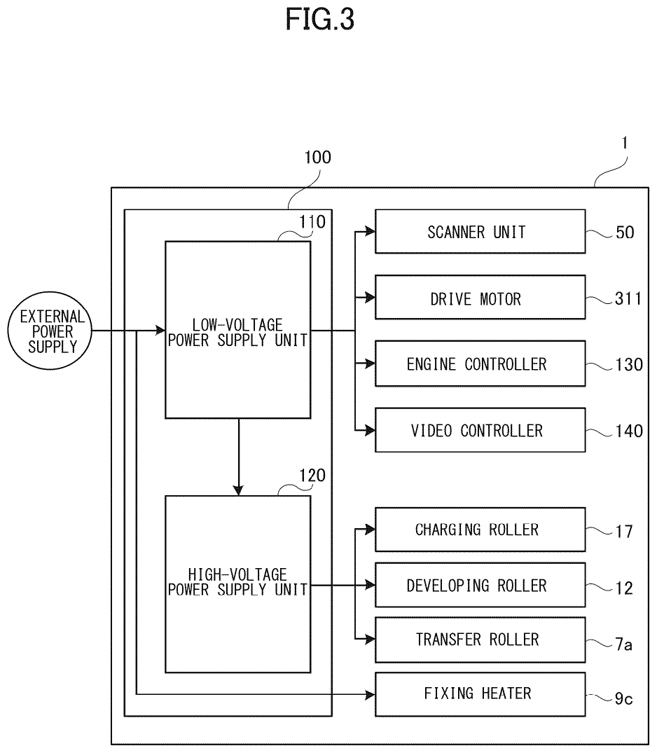

In addition, the photosensitive drum 11 is rotationally driven at a predetermined process speed in a predetermined rotation direction R by a drive motor 311 (FIG. 3) serving as a drive source at the time of image formation. The process speed during image formation can be set in a plurality of stages according to a type or a size of the recording material P, a use environment, or the like. In the image forming apparatus 1 of the present embodiment, the process speed is 140 mm/sec in a first mode corresponding to so-called plain paper of about 50 to 100 g/m² in weighing of the recording material P, for example, and 93 mm/sec in a second mode corresponding to so-called thick paper of about 100 to 300 g/m².

The charging roller 17 is in contact with the photosensitive drum 11 with a predetermined pressure contact force to form a charging portion. Further, a desired charging voltage is applied by a charging high-voltage power supply so that a surface of the photosensitive drum 11 is uniformly charged to a predetermined potential. In the present embodiment, the photosensitive drum 11 is negatively charged by the charging roller 17.

The scanner unit 50 scans and exposes the surface of the photosensitive drum 11 by irradiating the photosensitive drum 11 with laser beam corresponding to the image information input from an external device using a polygon mirror. By this exposure, an electrostatic latent image corresponding to the image information is formed on the surface of the photosensitive drum 11. Note that the scanner unit 50 is not limited to a laser scanner device, and for example, an LED exposing unit having an LED array in which a plurality of LEDs are arranged along a longitudinal direction of the photosensitive drum 11 may be adopted.

A developing unit of the present embodiment adopts a magnetic one-component jumping developing method. The developing unit includes a developing roller 12 serving as a toner bearing member (developer bearing member) rotatable facing the photosensitive drum 11. The developing roller 12 rotates while bearing a toner as a developer stored in the toner storage 18. The developing unit includes a metal blade that comes into contact with the developing roller 12, and the metal blade regulates a layer thickness of the toner and frictionally charges the toner with the rotation of the developing roller 12. The toner has magnetism and is held on the developing roller 12 by a magnet in the developing roller 12. The developing roller 12 of the present embodiment is a cylindrical member having a magnet arranged inside, and is also referred to as a developing sleeve.

A gap is provided between the surface of the photosensitive drum 11 and the developing roller 12. A portion where the photosensitive drum 11 and the developing roller 12 face each other across the gap is referred to as a developing portion. A voltage obtained by superimposing a rectangular wave AC voltage on a DC voltage is applied as a developing voltage to the developing roller 12. The toner on the developing roller 12 flies in a cloud shape toward the surface of the photosensitive drum 11, and is transferred to the surface of the photosensitive drum 11 according to a potential distribution on the photosensitive drum 11 (jumping development). As a result, the electrostatic latent image on the surface of the photosensitive drum 11 is developed into a toner image.

The cleaning unit 13 includes a cleaning blade 13a and a cleaning container 13b that stores the toner collected by the cleaning blade 13a. The cleaning blade 13a includes a stainless plate (stainless use steel: SUS sheet metal) and an elastic rubber tip crimped to a tip (free end) of the sheet metal. The tip of the rubber tip of the cleaning blade 13a is brought into contact with the photosensitive drum 11 at a predetermined angle and a predetermined penetration amount (distance). The cleaning unit 13 removes a residual toner on the surface of the photosensitive drum 11 by the tip of the rubber tip. The cleaning blade 13a is an example of a cleaning member that cleans the surface of the photosensitive drum 11, and for example, a brush that rubs the surface of the photosensitive drum 11 may be used as the cleaning member.

The transfer roller 7a is urged toward the photosensitive drum 11 by an urging member (not illustrated). A transfer nip N1 as a transfer portion in which the toner image is transferred to the recording material P as a member to be transferred is formed between the transfer roller 7a and the photosensitive drum 11.

As the fixing unit 9, a film heating-type fixing unit that can shorten a start-up time by using a film having a small heat capacity as a fixing member is used. The fixing unit 9 includes a fixing film 9a incorporating a fixing heater 9c, and a pressure roller 9b that comes into pressure contact with the fixing film 9a. Grease is applied to a portion being in contact with the fixing heater 9c, of an inner surface of the fixing film 9a, to stabilize traveling of the fixing film 9a. A fixing nip N2 is formed as a nip portion between the fixing film 9a and the pressure roller 9b.

The pressure roller 9b is rotationally driven by the drive motor 311 (FIG. 3) serving as a drive source, and the fixing film 9a receives a frictional force from the pressure roller 9b at the fixing nip N2 to rotate following the pressure roller 9b. The fixing unit 9 performs image fixing processing by heating and pressurizing the toner on the recording material while nipping and conveying the recording material P at the fixing nip N2.

The feeding unit 30 includes a cassette 4 serving as a sheet supporting unit on which the recording material P is stacked, a pickup roller 3 serving as a feeding member, a feed roller 5a, and a separation roller 5b. A front cover 70 is provided on an end surface on a front side of the image forming apparatus 1. The front cover 70 covers a circuit board 100.

Further, the image forming apparatus 1 includes a casing 72. The casing 72 includes the front cover 70, a sheet discharge tray 14, a back cover 73, and an exterior cover 71. The exterior cover 71 constitutes an exterior of the image forming apparatus 1 other than the front cover 70, the sheet discharge tray 14, and the back cover 73. In the casing 72, a discharge port 15 through which a sheet to be discharged to the sheet discharge tray 14 passes is formed. The sheet discharge tray 14 is provided on an upper surface of the image forming apparatus 1.

The image forming apparatus 1 includes a conveyance roller pair 5c, a sheet discharge roller pair 10, a duplex conveyance roller pair 5d, a main conveyance path 19, and a duplex conveyance path 16. The conveyance roller pair 5c is disposed between the feed roller 5a and the transfer nip N1 in a conveying direction of the recording material P. The sheet discharge roller pair 10 is a sheet discharge member that discharges the recording material P to the outside of the apparatus, and is disposed at the discharge port 15. The duplex conveyance roller pair 5d is disposed in the duplex conveyance path 16.

The main conveyance path 19 is a conveyance path from the feed roller 5a to the sheet discharge roller pair 10 via the conveyance roller pair 5c, the transfer nip N1, and the fixing nip N2. A part of the main conveyance path 19 is formed by a conveyance guide portion 7e of the transfer unit 7 to be described below. The duplex conveyance path 16 is a conveyance path that branches from the main conveyance path 19 at a position downstream of the fixing unit 9 and joins the main conveyance path 19 at a position upstream of the conveyance roller pair 5c. A part of the duplex conveyance path 16 is formed by conveyance guide portions 73g and 7d of the back cover 73 and the transfer unit 7 to be described below. The conveyance guide portions 73g, 7d, and 7e are, for example, a plurality of conveyance ribs extending along a recording material conveying direction, and are constituted by the plurality of conveyance ribs arranged in a width direction (X-axis direction) orthogonal to the recording material conveying direction.

As illustrated in FIG. 2, the image forming apparatus 1 includes the circuit board 100. The circuit board 100 includes a wiring board 101 made of an insulator and electronic components 111 and 121 soldered to the wiring board 101. The electronic components 111 and 121 are components of a low-voltage power supply unit 110 or a high-voltage power supply unit 120 to be described below. Since conductor wiring is provided on or inside the board of the wiring board 101, the electronic components 111 and 121 are electrically connected. The circuit board 100 has a function to convert an alternating current supplied from the outside of the image forming apparatus 1 into a direct current and a function to convert an input voltage in order to obtain a predetermined voltage value necessary for an image forming process.

In the following description and each drawing, a vertical direction (gravity direction) when the image forming apparatus 1 is installed on a horizontal plane is defined as a Z-axis direction. A rotation shaft direction of the photosensitive drum 11 included in the image forming apparatus 1 is defined as an X-axis direction. A direction intersecting with both the Z-axis direction and the X-axis direction is defined as a Y-axis direction. The X-axis direction, the Y-axis direction, and the Z-axis direction are favorably orthogonal to one another. Further, in a case of distinguishing one side and the other side in each of the X, Y, and Z-axis directions, the one side and the other side are denoted by symbols + (plus) and − (minus). For example, a positive direction of the X axis (a direction indicated by the arrow X in the drawing) is defined as a +X side, and a negative direction of the X axis (a side opposite to the arrow X) is defined as a −X side.

In the Y-axis direction, a downstream side (+Y side) in a discharge direction of the recording material by the sheet discharge roller pair 10 is referred to as “front side” or “front surface side”, and the opposite side (−Y side) is referred to as “rear side” or “back side”. Further, a right hand side (+X side) when the image forming apparatus 1 is viewed from the front side (+Y side) is referred to as “right direction” or “right side”, and the opposite side (−X side) is referred to as “left direction” or “left side”.

### Image Formation Operation

Next, an image formation operation of the image forming apparatus 1 will be described. When an image formation command is input to the image forming apparatus 1, the image forming unit 20 starts to create the toner image on the basis of the image information input from an external computer connected to the image forming apparatus 1.

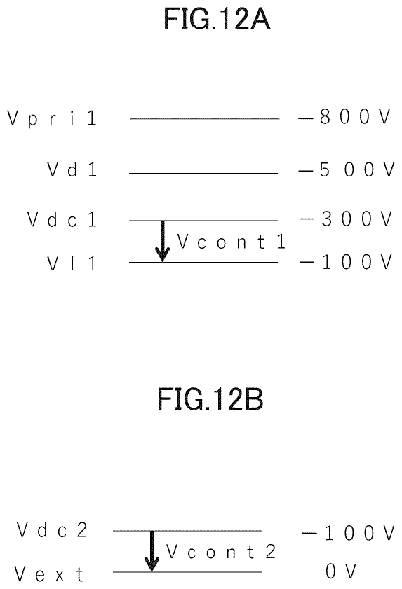

The charging roller 17 serving as a charging member is in contact with the photosensitive drum 11 with a predetermined pressure contact force to form the charging portion. A negative charging voltage is applied to the charging roller 17 by the high-voltage power supply unit 120 (see FIG. 3). As a result, the surface of the photosensitive drum 11 is uniformly charged to a dark potential Vd1. At the time of image formation, a charging voltage Vpri1 obtained by superimposing an AC component having a duty of 50%, a frequency of 1500 Hz, and a peak-to-peak voltage of 2000 V on a DC component of −800 V is applied to the charging roller 17 so that the dark potential Vd1 is −800 V (see FIG. 12A).

The scanner unit 50, which is an exposure unit, outputs laser beam corresponding to the image information input from an external device such as a host computer, and scans and exposes the surface of the photosensitive drum 11. By the exposure, an electrostatic latent image (electrostatic image) corresponding to the image information is formed on the surface of the photosensitive drum 11. In the present embodiment, an absolute value of a surface potential of the photosensitive drum 11 formed by the uniform charging processing decreases from the dark potential Vd1 by being exposed by the scanner unit 50, and becomes a bright potential Vl1. In the present embodiment, the bright potential Vl1 is −100 V (see FIG. 12A).

In the present embodiment, the developing roller 12 is disposed in non-contact with the photosensitive drum 11 (jumping developing method). Therefore, the developing voltage containing the AC component is applied to the developing roller 12. In the present embodiment, a developing voltage obtained by superimposing an AC component having a duty of 50%, a frequency of 3 kHz, and 1750 V (peak-to-peak voltage) on a DC component of −300 V is applied so that a developing potential Vdc1 is −300 V (see FIG. 12A).

At the time of image formation, the toner borne on the developing roller 12 is transferred to an image region on the photosensitive drum 11 by electrostatic force generated by a potential difference between the developing potential Vdc1 (=−300 V) and the bright potential Vl1 (=−100 V) that is the potential of the image region on the photosensitive drum 11. As a result, the electrostatic latent image on the surface of the photosensitive drum 11 is developed.

The pickup roller 3 of the feeding unit 30 feeds the recording material P supported by the cassette 4 in parallel with the above-described toner image forming process. The recording material P fed by the pickup roller 3 is further conveyed toward the conveyance roller pair 5c by the feed roller 5a. In a case where a plurality of the recording materials P enters the separation nip between the feed roller 5a and the separation roller 5b, the recording materials P are separated one by one by the separation roller 5b. Then, the recording material P is conveyed toward the transfer nip N1 by the conveyance roller pair 5c serving as a conveyance portion.

A transfer voltage is applied from the high-voltage power supply unit 120 (FIG. 3) to the transfer roller 7a. As a result, the toner image borne by the photosensitive drum 11 is transferred to the recording material P conveyed by the conveyance roller pair 5c. The recording material P to which the toner image has been transferred is conveyed to the fixing unit 9, and the toner image is heated and pressurized when passing through the fixing nip N2. As a result, toner particles are melted and then fixed, whereby the toner image is fixed to the recording material P. The recording material P having passed through the fixing unit 9 is discharged through the discharge port 15 to the outside of the image forming apparatus 1 (outside the apparatus) by the sheet discharge roller pair 10, and is stacked on the sheet discharge tray 14.

In a case where images are to be formed on both surfaces of the recording material P, the sheet discharge roller pair 10 conveys the recording material P to the duplex conveyance path 16 by switching back the recording material P having the image formed on a first surface. The recording material P conveyed to the duplex conveyance path 16 is conveyed again toward the transfer nip N1 by the duplex conveyance roller pair 5d. The recording material P passes through the transfer nip N1 and the fixing nip N2 to have an image formed on a second surface, and is then discharged to the outside of the apparatus by the sheet discharge roller pair 10. Note that the toner (transfer residual toner) remaining on the photosensitive drum 11 after the toner image is transferred to the recording material P is cleaned by the cleaning unit 13.

### Control Block

FIG. 3 is a block diagram for describing the functions of the circuit board 100 of the present embodiment. The circuit board 100 includes the low-voltage power supply unit 110 and the high-voltage power supply unit 120. The low-voltage power supply unit 110 takes in power from an external power supply (commercial power supply) via a power input unit (not illustrated) mounted on a board end portion, and converts an AC voltage into a stable DC voltage by a rectifying and smoothing circuit including an electrolytic capacitor. Furthermore, the low-voltage power supply unit 110 converts the DC voltage into a high-frequency AC voltage by a switching element such as a transistor, and inputs the high-frequency AC voltage to a low-voltage power supply transformer. The low-voltage power supply transformer converts the high-frequency AC voltage, which is an input voltage, into an AC voltage (output voltage) having a desired voltage value. The low-voltage power supply unit 110 converts the AC voltage into a DC voltage again, and outputs the obtained DC voltage to the high-voltage power supply unit 120. In the low-voltage power supply unit 110, since a loss of each circuit component is expressed as heat, a heat sink (not illustrated) made of aluminum or iron is provided to dissipate heat.

The high-voltage power supply unit 120 converts the voltage (for example, 24 V) supplied from the low-voltage power supply unit 110 into a high voltage necessary for the image forming process such as charging, development, and transfer. The voltage supplied from the low-voltage power supply unit 110 is supplied to the charging roller 17, the developing roller 12, and the transfer roller 7a.

The low-voltage power supply unit 110 supplies the voltage (for example, 3.3 V or 5 V) not only to the high-voltage power supply unit 120 but also to the scanner unit 50, the drive motor 311, an engine controller 130, and a video controller 140. The engine controller 130 serving as a control unit plays a role of integrally controlling various units (including the drive motor 311) in the image forming apparatus 1. The engine controller 130 includes a CPU, a RAM used for calculation and temporary storage of data necessary for controlling the image forming apparatus 1, a ROM for storing a program for controlling the image forming apparatus 1 and various data, and the like. The video controller 140 has a role of communicating with an external device such as a personal computer, receiving print data, and notifying the engine controller 130 of a result of analyzing the print data. Note that the engine controller 130 and the video controller 140 may be provided on a board different from the circuit board 100, or may be provided on the same board.

Further, the AC power from the external power supply received by the power input unit is supplied not only to the low-voltage power supply unit 110 but also to the fixing heater 9c. Note that driving of the various rotating members such as the pressure roller 9b in the fixing unit 9 is performed by the drive motor 311.

### Back Cover and Transfer Unit

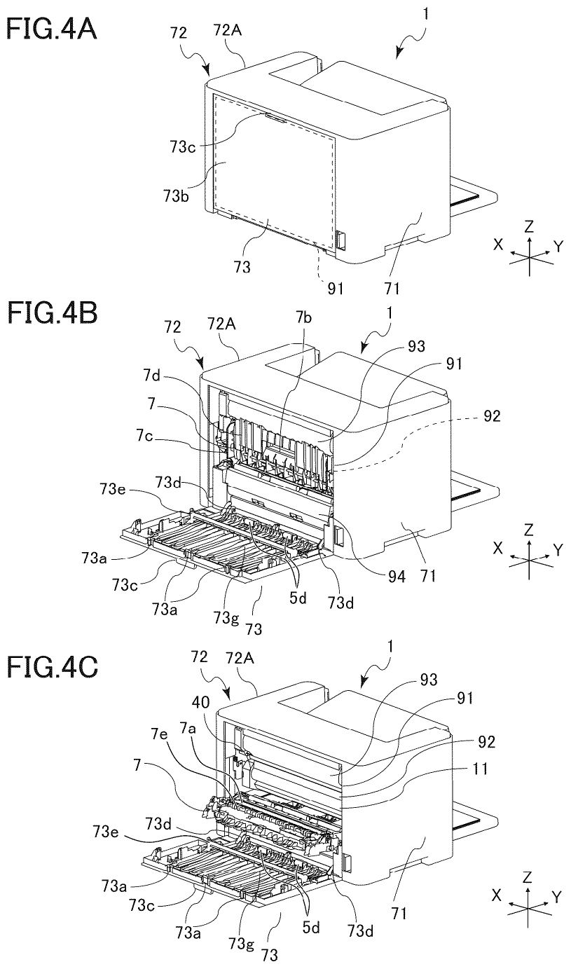

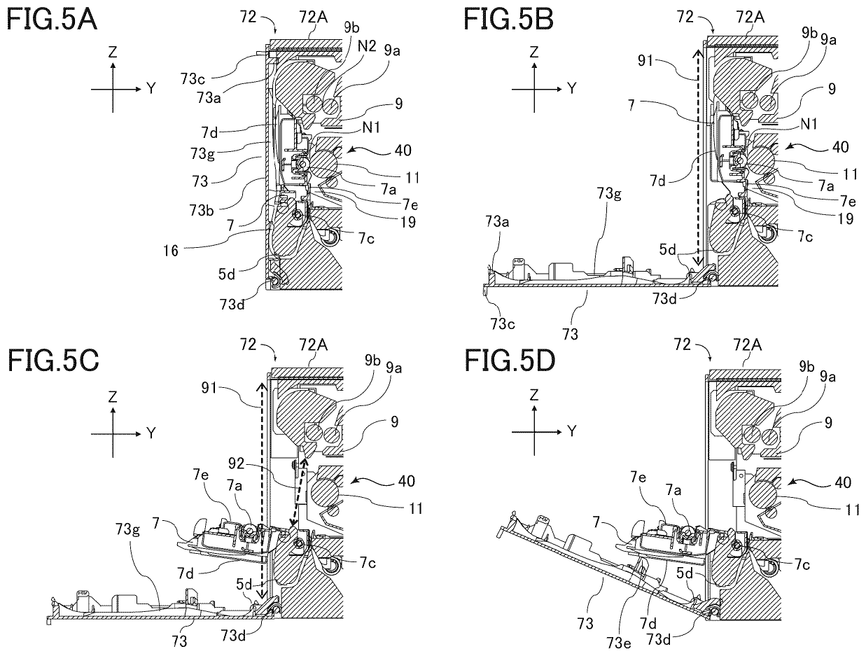

Next, the back cover 73 and the transfer unit 7 will be described with reference to FIGS. 4A to 5D. FIGS. 4A to 4C are perspective views mainly illustrating a configuration on the back side of the image forming apparatus 1. FIGS. 5A to 5D are cross-sectional views of the image forming apparatus 1 taken along a plane (Y-Z plane) perpendicular to a right-left direction.

Here, in the image forming apparatus, it is favorable that a user can visually confirm soiling on the photosensitive drum or the intermediate transfer belt which are image bearing members. However, even when the image bearing member is exposed by opening an opening/closing member or taking out a process cartridge, the user may be able to visually recognize only a part of an entire surface of the image bearing member. The present embodiment proposes a configuration in which soiling on the photosensitive drum 11 is easily visually recognized in a state where the back cover 73 as the opening/closing member is opened.

As illustrated in FIGS. 4A to 5D, an opening portion 91 (first opening portion or outer opening portion) formed in the exterior cover 71 and the back cover 73 covering the opening portion 91 are provided on the back surface of the image forming apparatus 1. Further, the transfer unit 7 is disposed inside the back cover 73.

The back cover 73 as the opening/closing member is provided so as to be openable/closable between an open position and a closed position. The closed position is a position at which the back cover 73 covers the opening portion 91 (FIGS. 4A and 5A). The open position is a position at which the back cover 73 is retracted from the opening portion 91 so that the opening portion 91 is exposed to the outside of the image forming apparatus 1 (FIGS. 4B, 4C, 5B, and 5C).

When the back cover 73 is at the closed position (FIGS. 4A and 5A), the transfer unit 7 and the process unit 40 are covered by the back cover 73. When the back cover 73 is at the open position (FIGS. 4B and 5B), the transfer unit 7 can be exposed to the outside of the image forming apparatus 1 through the opening portion 91.

The back cover 73 is an example of the opening/closing member that is movable between the open position where the opening portion 91 of the casing 72 is opened and the closed position where the opening portion 91 is closed. Further, the back cover 73 is an example of a unit that can take a first state in which a part of the surface of the photosensitive drum 11 is allowed to be exposed to the outside of the image forming apparatus 1 and a second state in which the surface of the photosensitive drum 11 is not exposed to the outside of the image forming apparatus 1. In the present embodiment, the state in which the back cover 73 is at the open position corresponds to the first state, and the state in which the back cover 73 is at the closed position corresponds to the second state.

The image forming apparatus 1 includes a cover opening/closing sensor S1 (FIG. 2) serving as a detection unit (opening/closing detection unit) capable of detecting opening/closing of the back cover 73. The cover opening/closing sensor S1 is configured to output a detection signal corresponding to whether the back cover 73 is at the closed position. The cover opening/closing sensor S1 is, for example, a contact switch arranged to detect a part (for example, an engaging claw 73a to be described below) of the back cover 73 at the closed position, but a detection method is not limited to the contact type. The engine controller 130 can detect the opening/closing of the back cover 73 on the basis of the detection signal of the cover opening/closing sensor S1.

The back cover 73 includes the engaging claw 73a, an outer surface 73b, a grip portion 73c, a pivot shaft 73d, a pressing rib 73e, and the conveyance guide portion 73g. The pressing rib 73e will be described below.

The outer surface 73b constitutes an exterior surface of the casing 72 together with the exterior cover 71 in the state where the back cover 73 is at the closed position (FIG. 4A). The grip portion 73c is provided on the outer surface 73b. The engaging claw 73a, the pressing rib 73e, and the conveyance guide portion 73g are arranged on an inner surface of the back cover 73 opposite to the outer surface 73b (FIG. 4B).

The engaging claw 73a is configured to be engaged with a portion to be engaged provided on the exterior cover 71. By the engagement between the engaging claw 73a (engaging portion) and the portion to be engaged, the back cover 73 is held at the closed position (FIGS. 4A and 5A). The grip portion 73c is a portion gripped by the user to operate the back cover 73. When the user grips and pulls the grip portion 73c toward the back side (−Y side) in the state where the back cover 73 is at the closed position, the user can disengage the engaging claw 73a from the portion to be engaged of the exterior cover 71 and move the back cover 73 from the closed position to the open position.

A portion other than the back cover 73 of the casing 72 is referred to as a casing body 72A. The back cover 73 is supported by the casing body 72A so as to pivotally move about the pivot shaft 73d (FIGS. 5A and 5B). The conveyance guide portion 73g forms the duplex conveyance path 16 (FIG. 5A) together with the conveyance guide portion 7d of the transfer unit 7 in the state where the back cover 73 is at the closed position.

The above-described fixing unit 9 (FIG. 2) is connected to opening/closing of the back cover 73 via a link mechanism. In the present embodiment, the pressure roller 9b is configured to move between a contact position where the pressure roller 9b is in contact with the fixing film 9a and a separated position where the pressure roller 9b is separated from the fixing film 9a in conjunction with the opening/closing of the back cover 73. The pressure roller 9b is configured to be held at the contact position during the image formation.

The transfer unit 7 includes the transfer roller 7a, the grip portion 7b, the pivot shaft 7c, and the conveyance guide portions 7d and 7e. The transfer unit 7 is supported by the casing body 72A so as to be openable/closable (pivotable) about the pivot shaft 7c.

The transfer unit 7 is provided so as to be openable/closable between the closed position (first position) and the open position (second position). The closed position is a position at which the transfer nip N1 is formed between the transfer roller 7a and the photosensitive drum 11 (FIGS. 5A and 5B). The closed position is a position at which the transfer unit 7 covers an opening portion 92 (second opening portion or inner opening portion) of the casing body 72A (FIGS. 4B and 5B). The open position is a position at which the transfer roller 7a is separated from the photosensitive drum 11 (FIGS. 4C and 5C). Further, when the back cover 73 is at the open position and the transfer unit 7 is at the open position, the surface of the photosensitive drum 11 is exposed to the outside of the image forming apparatus 1 through the opening portions 91 and 92.

The opening portion 92 is formed on an inner side (+Y side) of the casing body 72A with respect to the opening portion 91 (FIG. 4B) of the exterior cover 71. In the present embodiment, the opening portion 92 is formed between an upper guide 93 positioned above the transfer unit 7 (closed position) and a lower guide 94 positioned below the transfer unit 7 (closed position). Each of the upper guide 93 and the lower guide 94 includes a conveyance guide portion forming a part of the main conveyance path 19 and a conveyance guide portion forming a part of the duplex conveyance path 16. Further, the upper guide 93 and the lower guide 94 are fixed to the casing body 72A.

With reference to a posture of the transfer unit 7 at the closed position, a surface on the back side (−Y side) of the transfer unit 7 is defined as an outer surface, and a surface on the front side (+Y side) of the transfer unit 7 is defined as an inner surface. The conveyance guide portion 7d and the grip portion 7b are disposed on the outer surface of the transfer unit 7, and the conveyance guide portion 7e and the transfer roller 7a are disposed on the inner surface of the transfer unit 7.

### Case 1: Back Cover and Transfer Unit are Closed

FIGS. 4A and 5A illustrate a state in which the back cover 73 is in the closed position and the transfer unit 7 is in the closed position. In this case, apart of the duplex conveyance path 16 is formed between the conveyance guide portion 73g of the back cover 73 and the conveyance guide portion 7d of the transfer unit 7.

In addition, in the state where the back cover 73 is at the closed position and the transfer unit 7 is at the closed position, the recording material P can be conveyed through the transfer nip N1 and the toner image can be transferred at the transfer nip N1. That is, execution of an image formation operation by the image forming apparatus 1 is allowed.

Note that, in the state where the back cover 73 is at the closed position, the pressure roller 9b of the fixing unit 9 is in contact with the fixing film 9a. Further, in the present embodiment, in the state where the back cover 73 is located at the closed position, the transfer unit 7 is drawn into the image forming apparatus 1 by a link member (not illustrated) and held at the closed position.

### Case 2: Only Back Cover is Opened

FIGS. 4B and 5B illustrate a state in which the back cover 73 is in the open position and the transfer unit 7 is in the closed position. When the back cover 73 is moved from the closed position to the open position, the duplex conveyance path 16 (FIG. 4A) is opened.

As described above, in the present embodiment, the cover opening/closing sensor S1 is disposed on the exterior cover 71, and the engine controller 130 detects that the back cover 73 has been opened on the basis of the detection signal of the cover opening/closing sensor S1.

Further, the pressure roller 9b of the fixing unit 9 moves from the contact position to the separated position with respect to the fixing film 9a in conjunction with the movement of the back cover 73 from the closed position to the open position. Therefore, in a state where the back cover 73 is located at the open position and the duplex conveyance path 16 is opened, the pressure roller 9b is also separated from the fixing film 9a. That is, while a manual drive mode to be described below is performed in the state where the back cover 73 and the transfer unit 7 are opened, the pressure roller 9b and the fixing film 9a are separated during execution of the manual drive mode.

The reason why the pressure roller 9b and the fixing film 9a are separated in the manual drive mode is to prevent the fixing film 9a from rotating by a drive force of the drive motor 311 that is a common drive source of the photosensitive drum 11 and the fixing unit 9. Assume that the pressure roller 9b is rotationally driven and the fixing film 9a is rotated in a state where the fixing heater 9c is not energized. In this case, viscosity of the grease applied between the fixing film 9a and the fixing heater 9c is too high, and running of the fixing film 9a may become unstable. Meanwhile, a time during which the drive motor 311 rotationally drives the photosensitive drum 11 in the manual drive mode is short. For this reason, when the fixing heater 9c is energized in the manual drive mode, heat is accumulated in the fixing nip N2 while the drive motor 311 is stopped, and a defect such as melting of the fixing film 9a and the pressure roller 9b may occur due to overheating of the fixing heater 9c.

In the present embodiment, since the pressure roller 9b and the fixing film 9a are separated during the execution of the manual drive mode, the fixing film 9a is maintained in the stopped state even if the drive motor 311 rotationally drives the photosensitive drum 11 for a short time. Therefore, it is not necessary to energize the fixing heater 9c, and it is possible to prevent overheating of the fixing heater 9c.

Note that, instead of the configuration in which the pressure roller 9b is separated from the fixing film 9a, for example, a mechanism that interrupts drive transmission may be interposed between the drive motor 311 and the pressure roller 9b, and the drive transmission may be interrupted during the execution of the manual drive mode. Examples of the mechanism that interrupts drive transmission include a mechanism in which a gear that drives the pressure roller 9b is disengaged from a drive train from the drive motor 311 by laterally moving in conjunction with causing the back cover 73 to be in the open position, and a mechanism using an electromagnetic clutch. Further, a drive source that rotationally drives the fixing unit 9 may be added, and rotational driving of the fixing unit 9 may not be performed during the execution of the manual drive mode, in addition to the drive motor 311 that rotationally drives the photosensitive drum 11.

### Case 3: Back Cover and Transfer Unit are Opened

FIGS. 4C and 5C illustrate a state in which the back cover 73 is in the open position and the transfer unit 7 is in the open position. The user can move the transfer unit 7 from the closed position to the open position by gripping and pulling the grip portion 7b toward the back side (−Y side) in the state where the back cover 73 is at the open position.

When the transfer unit 7 is moved to the open position, the main conveyance path 19 is opened. Further, when the transfer unit 7 is moved to the open position, the surface of the photosensitive drum 11 can be visually recognized through the opening portion 92. That is, when the image forming apparatus 1 is viewed in the Y direction from the back side in the state where the back cover 73 is at the open position and the transfer unit 7 is at the open position, a part of the surface of the photosensitive drum 11 is exposed within the opening portion 92.

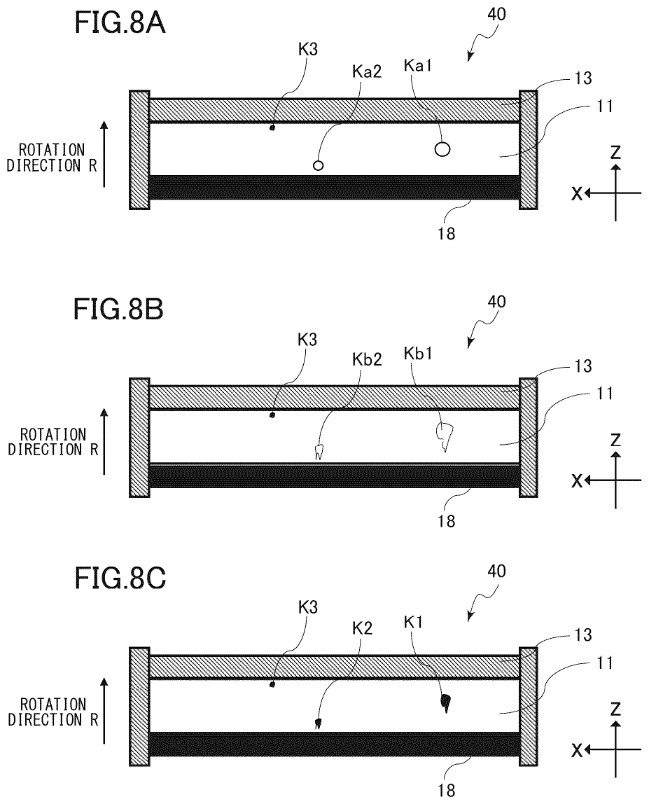

In the present embodiment, an area of a part (an exposed region or a region visible in the state of FIG. 8A) of the surface of the photosensitive drum 11 exposed in the state where the back cover 73 and the transfer unit 7 are at the open position is about ⅓ of an area of the entire surface of the photosensitive drum 11. A width of the exposed region of the photosensitive drum 11 as measured along an outer peripheral surface of the photosensitive drum 11 in the rotation direction of the photosensitive drum 11 is about 25 mm.

### Case 4: Back Cover is Closed

As illustrated in FIG. 5D, when the back cover 73 is moved toward the closed position in the state where the back cover 73 and the transfer unit 7 are at the open position, the pressing rib 73e comes into contact with the transfer unit 7. The pressing rib 73e presses the transfer unit 7 to move the transfer unit 7 to the closed position while the back cover 73 moves from the open position to the closed position.

Note that the user may manually move the transfer unit 7 from the open position to the closed position, and then move the back cover 73 from the open position to the closed position. Further, the pressing rib 73e may not be provided, and the transfer unit 7 may be configured not to interlock with the back cover 73.

### Jam Clearance

Next, a jam clearance method in a case where a jam occurs in the duplex conveyance path 16 or the main conveyance path 19 will be described. In a case where a jam of the recording material P occurs during the image formation operation, the image forming apparatus 1 interrupts the image formation operation and notifies the user of the occurrence of the jam. The user opens the back cover 73 to perform jam clearance (FIGS. 4B and 5B). As a result, the duplex conveyance path 16 is opened, and the recording material P stagnating in the duplex conveyance path 16 due to the jam can be removed.

Meanwhile, in a case where a jam occurs near the transfer nip N1, the user opens the transfer unit 7 after opening the back cover 73 as illustrated in FIGS. 4C and 5C. As a result, since the main conveyance path 19 is opened, the user can remove the recording material P stagnating near the transfer nip N1.

Note that, in the present embodiment, the user removes the recording material P stagnating at the transfer nip N1 by opening the back cover 73 and the transfer unit 7 on the back side of the image forming apparatus 1, but the configuration for the jam clearance is not limited thereto. For example, the photosensitive drum 11 of the process unit 40 may be exposed by opening the sheet discharge tray 14 disposed in an upper portion of the image forming apparatus 1. In this case, after opening the sheet discharge tray and taking out the process unit 40 upward from the casing 72, the user can access the vicinity of the transfer nip N1 and remove the recording material P.

### Attachment/Detachment of Process Unit

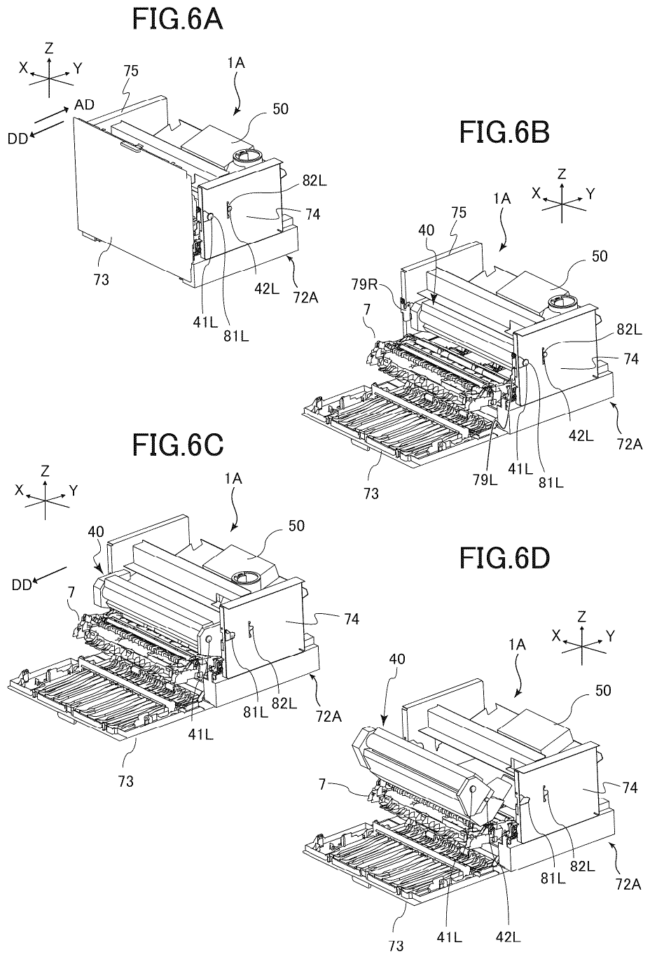

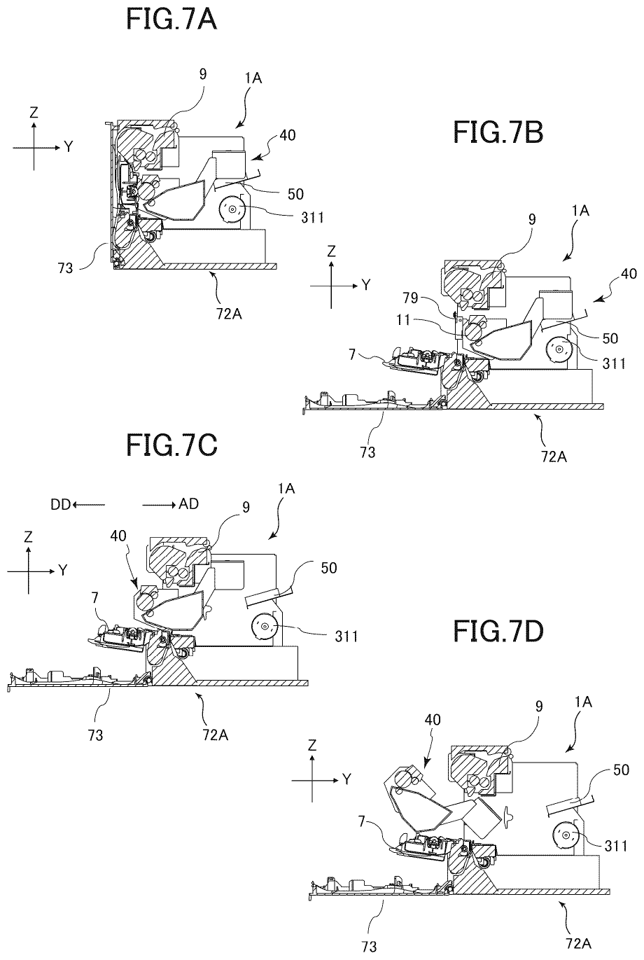

Next, a method of attaching/detaching the process unit 40 when, for example, the process unit 40 is replaced or the apparatus body 1A is maintained will be described with reference to FIGS. 6A to 7D. FIGS. 6A to 6D are perspective views of the image forming apparatus 1 as seen through the exterior cover 71, the sheet discharge tray 14, the front cover 70, and the like. FIGS. 7A to 7D are respectively cross-sectional views of the image forming apparatus 1 in the state illustrated in FIGS. 6A to 6D taken along a plane (Y-Z plane) perpendicular to the X-axis direction.

When detaching the process unit 40 from the image forming apparatus 1, the user moves the back cover 73 and the transfer unit 7 to the open position as illustrated in FIGS. 6A and 6B and FIGS. 7A and 7B. As a result, the process unit 40 is exposed to the outside of the image forming apparatus 1. However, in this state, the process unit 40 is fixed to a left side plate 74 and a right side plate 75 by fixing members 79 L and 79R.

The left side plate 74 and the right side plate 75 are frame members constituting a frame body of the image forming apparatus 1. The left side plate 74 and the right side plate 75 are a part of the casing 72 (casing body 72A). The left side plate 74 is a sheet metal member that is provided on one side (left side) of the casing 72 in the X-axis direction (right-left direction) and extends substantially perpendicularly to the X-axis direction. The right side plate 75 is a sheet metal member that is provided on the other side (right side) of the casing 72 in the X-axis direction (right-left direction) and expands substantially perpendicularly to the X-axis direction. In the casing body 72A, an attaching space in which the process unit 40 is attached is formed between the left side plate 74 and the right side plate 75 in the X-axis direction.

The fixing member 79 L is fixed to the left side plate 74 using screws. The fixing member 79R is fixed to the right side plate 75 using screws. The fixing members 79L and 79R attached to the left side plate 74 and the right side plate 75 regulates movement of the process unit 40 to the back side (−Y side).

Further, the left side plate 74 is provided with a positioning portion 81L and a rotation regulating portion 82L. Meanwhile, a positioning boss 41L and a rotation regulating boss 42L are disposed on a left end surface of the process unit 40. In a state where the process unit 40 is attached to the apparatus body 1A (FIGS. 6A and 7A), the positioning boss 41L is engaged with the positioning portion 81L, and the rotation regulating boss 42L is engaged with the rotation regulating portion 82L. The position of the process unit 40 in an attaching direction AD of the process unit 40 is determined by the engagement between the positioning boss 41L and the positioning portion 81L. Further, the rotation of the process unit 40 around the positioning boss 41L and the positioning portion 81L is regulated by the engagement between the rotation regulating boss 42L and the rotation regulating portion 82L, and the posture of the process unit 40 is determined.

Note that the right side plate 75 is also provided with a positioning portion and a rotation regulating portion corresponding to the positioning portion 81L and the rotation regulating portion 82L. A positioning boss engaged with the positioning portion of the right side plate 75 and a rotation regulating boss engaged with the rotation regulating portion 82L of the right side plate 75 are disposed on a right end surface of the process unit 40.

Note that, in the present embodiment, the process unit 40 is fixed to the left side plate 74 and the right side plate 75 using the fixing members 79L and 79R and the screws, but the method of fixing the process unit 40 is not limited thereto. For example, the process unit 40 may be held at a predetermined position in the apparatus body 1A by an urging member using a spring or the like. Further, the process unit 40 may be held at a predetermined position in the apparatus body 1A by using a force by which the transfer roller 7a of the transfer unit 7 presses the photosensitive drum 11.

After moving the back cover 73 and the transfer unit 7 to the open position, the user detaches the fixing members 79L and 79R from the left side plate 74 and the right side plate 75. As illustrated in FIGS. 6C and 7C, the user moves the process unit 40 in a detaching direction DD opposite to the attaching direction AD with respect to the casing body 72A. Further, with the movement of the process unit 40 in the detaching direction DD, a coupling portion (drive transmission portion) for transmitting the drive force of the drive motor 311 (FIG. 7C) to the process unit 40 is disconnected.

By the movement of the process unit 40 in the detaching direction DD, the positioning boss 41L and the rotation regulating boss 42L on the left side of the process unit 40 are disengaged from the positioning portion 81L and the rotation regulating portion 82L of the left side plate 74, respectively. The positioning boss and the rotation regulating boss on the right side of the process unit 40 are also disengaged from the positioning portion and the rotation regulating portion of the right side plate 75, respectively. Then, the user detaches the process unit 40 from the apparatus body 1A through the opening portions 91 and 92 (FIG. 4C) of the casing body 72A (FIGS. 6D and 7D).

A procedure of attaching the process unit 40 to the apparatus body 1A is reverse to the above procedure of detaching. That is, in the state where the back cover 73 is located at the open position and the transfer unit 7 is located at the open position, the user inserts the process unit 40 into the apparatus body 1A in the attaching direction AD through the opening portions 91 and 92. After engaging the positioning boss 41L and the rotation regulating boss 42L of the process unit 40 with the positioning portion 81L and the rotation regulating portion 82L, the user attaches the fixing members 79L and 79R to the left side plate 74 and the right side plate 75. As a result, the process unit 40 is attached to a predetermined position in the apparatus body 1A.

As described above, the process unit 40 is attachable/detachable to/from the apparatus body 1A in the state where the back cover 73 is located at the open position and the transfer unit 7 is located at the open position.

Note that, in the present embodiment, the process unit 40 is detached from the apparatus body 1A through the opening portions 91 and 92 on the back side. However, the process unit 40 may be detached in a direction other than the backside. For example, the process unit 40 may be exposed by opening the sheet discharge tray 14 as described above, and the process unit 40 may be detached upward from the apparatus body 1A.

### Soiling Adhesion to Surface of Photosensitive Drum

Next, a process in which soiling adheres to the surface of the photosensitive drum 11 will be described. As described above, at the time of jam clearance or replacement of the process unit 40, a part of the surface of the photosensitive drum 11 is exposed to the outside of the image forming apparatus 1. Therefore, there is a possibility that dust, dirt, or the like around the image forming apparatus 1 directly adheres to the surface of the photosensitive drum 11, or sebum adheres when the user unexpectedly touches the surface of the photosensitive drum 11.

In a case where the image formation operation is executed while leaving the soiling adhering to the surface of the photosensitive drum 11, there is a possibility that an image defect due to the soiling occurs. Examples of the soiling that is likely to cause the image defect include food such as fruit juice and starch, cosmetics such as hand cream and sunscreen, and stationery such as glue and tape, in addition to greasy dirt such as sebum. That is, in a case where various substances used in daily life adhere to the surface of the photosensitive drum 11, the image defect may occur.

### Image Defect

A process in which the image defect occurs due to soiling adhering to the surface of the photosensitive drum 11 will be described with reference to FIGS. 8A to 8C. FIGS. 8A to 8C are schematic views illustrating a state in which the process unit 40 is viewed from the back side in the state where the back cover 73 and the transfer unit 7 are at the open positions. As described above, in the state where the back cover 73 and the transfer unit 7 are at the open positions, a region corresponding to ⅓ (peripheral width: 25 mm) of the entire surface of the photosensitive drum 11 can be visually recognized.

FIG. 8A illustrates a state in which soiling Ka1 and Ka2 adhere to the surface of the photosensitive drum 11. FIG. 8B illustrates a state after the photosensitive drum 11 has rotated several times after a print job (an execution command of the image formation operation) was sent to the image forming apparatus 1 and the image formation operation was executed after the soiling Ka1 and Ka2 adhered.

The soiling Ka1 and Ka2 adhering to the photosensitive drum 11 may be scraped off by passing through the cleaning unit 13, but in a case where droplets of the soiling are large or viscosity of the droplets is high, the soiling Ka1 and Ka2 may not be scraped off by passing once. When the soiling is stretched at the time of passing through the cleaning unit 13, tear-shaped soiling Kb1 and Kb2 may be formed as illustrated in FIG. 8B.

FIG. 8C illustrates a state after the image formation operation has been repeated a plurality of times in the state of FIG. 8B. In a case where the portion where the soiling remains overlaps the region (image region) where the toner image is developed on the surface of the photosensitive drum 11, the toner electrically attracted from the developing roller 12 during the image formation operation adheres to the soiling on the photosensitive drum 11. The toner adhering to the soiling is repeatedly rubbed by the charging roller 17 and the cleaning unit 13 in contact with the photosensitive drum 11. As a result, although the size of the soiling is reduced, the toner may be crushed on the soiling to form toner lumps K1 and K2.

In a case where the toner lump is in a soft state such as a case where the soiling has just adhered onto the photosensitive drum 11 and the soiling contains moisture, it is possible to easily remove the toner lump by lightly pressing a clean cloth or the like against the toner lump and wiping off the toner lump. In addition, in a case where the toner lumps are still soft, the photosensitive drum 11 rotates by repeated print jobs, and the toner lumps K1 and K2 on the photosensitive drum 11 repeatedly pass through the cleaning unit 13, so that the toner lumps may gradually become small and disappear.

However, when it takes time to start the next print job after the toner adheres to the soiling and the toner lumps K1 and K2 are formed, the moisture of the soiling evaporates and dries. In a dry state, the toner lumps K1 and K2 become hard, and the toner lumps K1 and K2 are firmly fixed to the surface of the photosensitive drum 11.

A toner lump K3 illustrated in FIGS. 8A to 8C is a toner lump fixed to the surface of the photosensitive drum 11 after being left for along period of time. There is a case where such a toner lump K3 continues to remain on the photosensitive drum 11 without being scraped even after repeatedly passing through the cleaning unit 13.

In the toner lumps K1, K2, and K3 fixed to the surface of the photosensitive drum 11, light from the scanner unit 50 does not reach the photosensitive layer even in the image region, and the surface potential of the photosensitive drum 11 does not become the bright potential Vl1. Then, the potential in the region where the toner lumps K1, K2, and K3 exist on the surface of the photosensitive drum 11 becomes higher than the developing potential Vdc1 (the surface of the photosensitive drum 11 is more negative than the developing roller 12), so that the toner image is not developed in the region where the toner lumps K1, K2, and K3 exist. As a result, image defects (hereinafter referred to as white spots) occur in which an image comes out white at positions on the recording material P corresponding to the regions where the toner lumps K1, K2, and K3 exist.

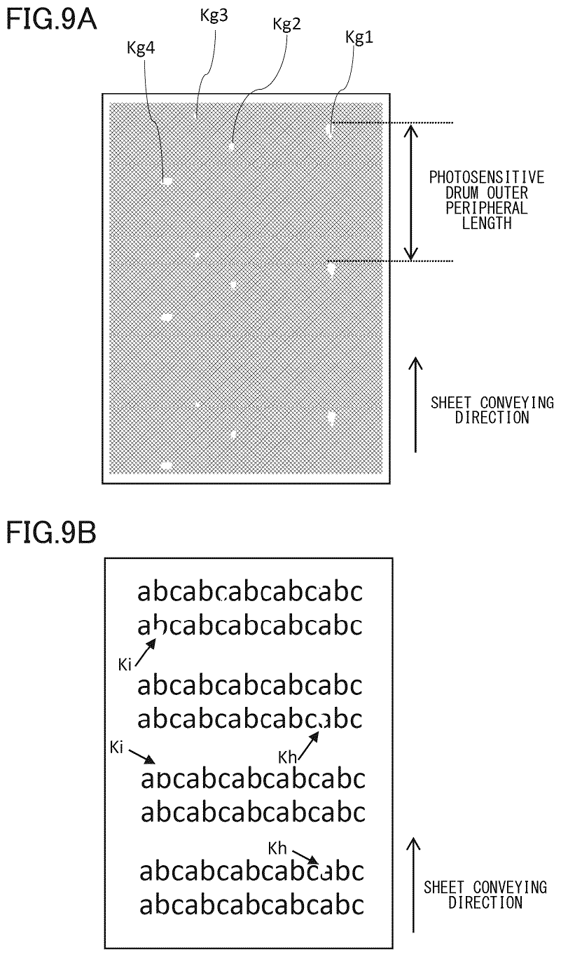

FIGS. 9A and 9B are examples of images in which the white spots have occurred. FIG. 9A illustrates a case where a full-surface halftone image is printed on A4 paper in the state where there is a toner lump fixed on the photosensitive drum 11, and FIG. 9B illustrates a case where a character image is printed on A4 paper in a similar state.

In the example of FIG. 9A, white spots Kg1, Kg2, and Kg3 correspond to the toner lumps K1, K2, and K3 in FIG. 8C, respectively. As illustrated in FIG. 9A, the white spots periodically occur at intervals corresponding to an outer peripheral length of the photosensitive drum 11 in a sheet conveying direction that is a sub-scanning direction at the time of image formation. In the present embodiment, the photosensitive drum 11 having a diameter of 24 mm (outer peripheral length of about 75 mm) is used. For this reason, in the case of the A4 sheet, the white spots may occur at three places per toner lump on one sheet.

As illustrated in FIG. 9B, even in the case where a character image is formed on the recording material P, when the image region overlaps a fixing portion of the toner lump on the photosensitive drum 11, an image defect (portions indicated by the arrows Kh in the drawing) in which a part of the character is missing may occur.

Here, the character missing indicated by the white spot Kg4 in FIG. 9A and the arrows Ki in FIG. 9B are caused by the toner lump fixed to a region that cannot be visually recognized in FIG. 8C on the surface of the photosensitive drum 11. As described above, since a part of the entire surface of the photosensitive drum 11 can be visually confirmed by the user at a time, in a case where a toner lump adheres to a part that cannot be visually confirmed, the toner lump cannot be removed even if an attempt to clean the toner lump to be described below is made, and an image defect may not be eliminated.

### Cleaning of Toner Lump

A method of cleaning soiling and a toner lump attached to the surface of the photosensitive drum 11 will be described. First, the user opens the back cover 73 and the transfer unit 7 to expose the photosensitive drum 11, and observes the surface of the photosensitive drum 11. When the toner lump causing the white spot is found by observation, the user removes the toner lump by repeatedly rubbing the toner lump with a clean cloth or wiping the toner lump while softening the toner lump with clean water contained in the cloth while being careful not to damage the photosensitive drum 11.

The cloth to be used is favorably a cloth from which lint does not easily come out. This is because, in the case of a cloth from which lint easily comes out, there is a possibility that the lint adheres to the photosensitive drum 11 at the time of wiping, and the white spots are generated again starting from the lint with soiling. In addition, it is desirable to perform cleaning by fitting new gloves so that sebum or the like does not adhere to the photosensitive drum 11 when the user touches the photosensitive drum again during cleaning. The glove is favorably made of disposable latex or nitrile. The water used for cleaning is favorably drinking water, distilled water, deionized water, or the like.

Note that, as described above, since only a part of the entire surface of the photosensitive drum 11 can be visually confirmed by the user at a time, in a case where a toner lump adheres to a part that cannot be visually confirmed, there is a possibility that a part of the toner lump remains even after cleaning.

To confirm the presence or absence of the soiling or the toner lump on the entire surface of the photosensitive drum 11, it is required to change a rotation angle (rotation phase) of the photosensitive drum 11. Here, for example, it is assumed that the user takes out the process unit 40 from the image forming apparatus 1 and manually changes the rotation angle of the photosensitive drum 11. However, in a case where a load torque for rotating the photosensitive drum 11 is large, it is difficult to manually change the rotation angle. In addition, even if the rotation angle of the photosensitive drum 11 can be manually changed, it is difficult to grasp a visually confirmed region and an unconfirmed region on the surface of the photosensitive drum 11, and there is a possibility that the soiling or the toner lump is overlooked.

### Manual Drive Mode

The image forming apparatus 1 of the present embodiment has the manual drive mode as a function to assist work of checking the surface of the photosensitive drum 11. The manual drive mode is a mode in which the photosensitive drum 11 is rotationally driven on the basis of an instruction from the user in a state where a part of the surface of the photosensitive drum 11 can be visually recognized from the outside of the image forming apparatus 1. That is, the manual drive mode is a mode in which the photosensitive drum 11 is rotationally driven by the drive motor 311 in the state (first state) in which the back cover 73 serving as a unit of the present embodiment is at the open position.

Since the photosensitive drum 11 is rotationally driven in the state where a part of the surface of the photosensitive drum 11 is exposed to the outside, it is easy for the user to confirm whether the soiling or the toner lump adheres to the surface of the photosensitive drum 11. In addition, by controlling the rotation amount of the photosensitive drum 11, it is possible to reduce the possibility of occurrence of overlooking of the soiling or the toner lump. Hereinafter, details of the manual drive mode will be described.

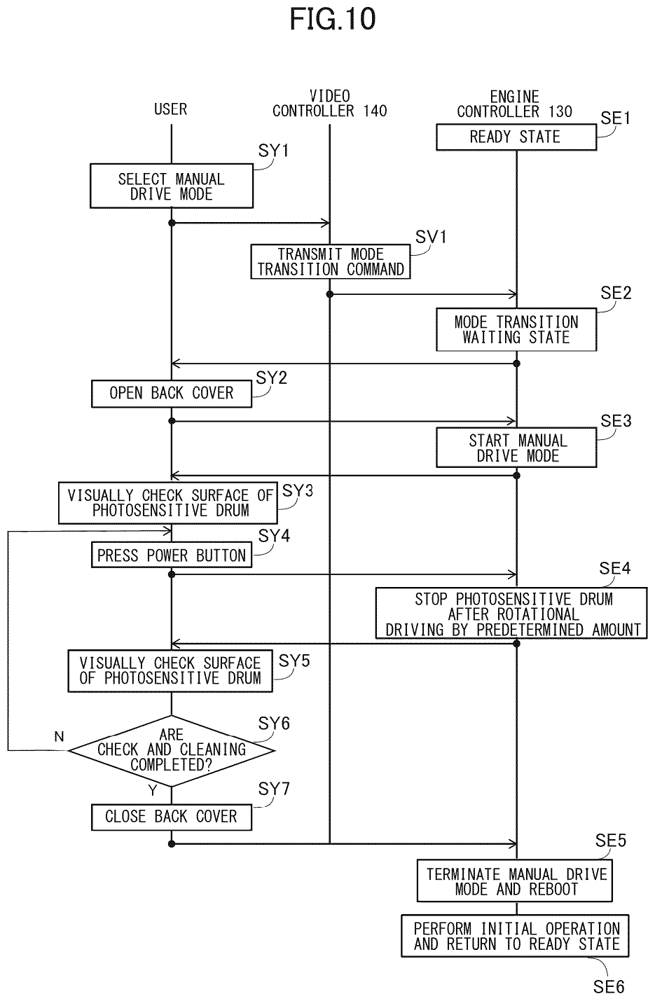

FIG. 10 is an example of a sequence diagram of the manual drive mode. In the present embodiment, the manual drive mode is implemented as a function of the engine controller 130.

At the start of this sequence, it is assumed that the engine controller 130 is in a ready state (SE1). The ready state is a state (standby state) in which the image formation operation can be started when a print job is input.

The user selects transition to the manual drive mode on a driver screen (SY1). The driver screen may be an operation screen displayed on a display of an external computer communicatively connected to the image forming apparatus 1 or an operation screen displayed on a display unit (operation panel) included in the image forming apparatus 1. The video controller 140 that has received the user's selection transmits a command for transitioning to the manual drive mode to the engine controller 130 (SV1). When receiving the command, the engine controller 130 enters a mode transition waiting state (SE2).

In the mode transition waiting state (SE2), the user moves the back cover 73 from the closed position to the open position (SY2). When detecting that the back cover 73 is opened on the basis of the detection signal of the cover opening/closing sensor S1, the engine controller 130 determines that the rotational driving of the photosensitive drum 11 can be started according to an instruction from the user, and enters the manual drive mode (SE3). During the execution of the manual drive mode, the engine controller 130 can rotationally drive the photosensitive drum 11 on the basis of the instruction from the user.

The user moves the transfer unit 7 to the open position following the back cover 73 to expose the surface of the photosensitive drum 11, and checks whether the soiling or the toner lump adheres to the surface of the photosensitive drum 11 (SY3). If the soiling or the toner lump adheres, cleaning with a cloth or the like may be performed at this stage.

When the user presses a power button 80 (FIG. 1) during the execution of the manual drive mode (SY4), the engine controller 130 operates the drive motor 311 to rotate the photosensitive drum 11 (SE4). A driving speed of the photosensitive drum 11 (peripheral speed of the photosensitive drum 11) in the operation of SE4 was set to 93 mm/sec. This driving speed is the same as a process speed in a mode of the print job using thick paper (second mode), and is lower than the process speed in the case of using plain paper (first mode). The driving speed of the photosensitive drum 11 in the operation of SE4 may be set to a speed different from the process speed in the second mode.

After the rotational driving of the photosensitive drum 11 is started in SE4, the engine controller 130 stops the rotation of the photosensitive drum 11 in a state where a region of the surface of the photosensitive drum 11 different from the region exposed to the outside of the image forming apparatus 1 before the start of the rotational driving is exposed. That is, in the manual drive mode, the engine controller 130 causes the drive motor 311 to start the rotation of the photosensitive drum 11 in a state where a first area on the surface of the photosensitive drum 11 is exposed to the outside of the image forming apparatus 1, and then stops the rotation of the photosensitive drum 11 in a state where a second area different from the first area on the surface is exposed to the outside of the image forming apparatus 1. Therefore, the user can confirm a region where the photosensitive drum 11 is not exposed in a stationary state.

In the present embodiment, every time the user presses the power button 80 serving as an operation unit once, the engine controller 130 executes a unit operation of rotating the photosensitive drum 11 by a predetermined amount and then stopping the rotation of the photosensitive drum 11 once. Therefore, the user simply repeats a series of operations of pressing the power button 80 after checking and cleaning the current exposed region of the photosensitive drum 11.

A rotation amount (predetermined amount) by which the photosensitive drum 11 is rotationally driven in one unit operation is set such that the surface of the photosensitive drum 11 moves by about 19 mm. A moving distance of about 19 mm corresponds to about ¼ of the outer peripheral length of the photosensitive drum 11. That is, the moving distance of the surface of the photosensitive drum 11 in one unit operation is narrower than the width (about 25 mm) of the exposed region of the surface of the photosensitive drum 11 exposed in the state where the back cover 73 and the transfer unit 7 are at the open position.

Therefore, parts of the exposed regions overlap before and after the unit operation. In other words, a part of the exposed region (first area) of the surface of the photosensitive drum 11 before the unit operation is performed overlaps a part of the exposed region (second area) after the unit operation is performed. For this reason, a region that cannot be visually observed by the user is less likely to occur, and the possibility of causing overlooking of the soiling or the toner lump can be reduced.

After pressing the power button 80 in SY4, the user checks adhesion of the soiling or the toner lump to the surface of the photosensitive drum 11 newly exposed by the rotation of the photosensitive drum 11 (SY5). The user repeatedly performs the work of SY4 and SY5 until the entire surface of the photosensitive drum 11 is confirmed (SY6). In the present embodiment, when the power button 80 is pressed three times, the entire surface of the photosensitive drum 11 is confirmed. For example, the engine controller 130 may notify the user that the photosensitive drum 11 has been rotated by one rotation (that the entire surface of the photosensitive drum 11 has been confirmed) by displaying a message on the driver screen.

Note that, even after the photosensitive drum 11 is rotationally driven by one rotation, the user may repeat the work of SY4 and SY5 until the user thinks that the adhesion of the soiling or the toner lump has been sufficiently confirmed. That is, in a case where the user thinks that there is still soiling or the toner lump on the surface of the photosensitive drum 11, or in a case where the user desires more careful check, the user may return to SY4 in the determination of SY6 and continue the work.

In a case where the user has sufficiently confirmed that no soiling or toner lump adheres to the entire surface of the photosensitive drum 11 (SY6Y), the user terminates the manual drive mode. To terminate the manual drive mode, the user closes the back cover 73 (SY7). When detecting that the back cover 73 is closed on the basis of the detection signal of the cover opening/closing sensor S1, the engine controller 130 terminates the manual drive mode and reboots (restarts) (SE5). After the reboot, the engine controller 130 performs an initialization operation in preparation for an input of a print job to be in the ready state, and terminates this flow (SE6).

As described above, the image forming apparatus 1 of the present embodiment can execute the manual drive mode as a mode of rotationally driving the photosensitive drum 11 in the state where a part of the surface of the photosensitive drum 11 is exposed to the outside of the image forming apparatus 1. Accordingly, the user can easily check the soiling on the surface of the photosensitive drum 11.

Note that, in the present embodiment, a sensor for detecting opening/closing of the transfer unit 7 is not provided. In the manual drive mode, the photosensitive drum 11 can be rotationally driven while the transfer unit 7 is at the closed position. In other words, in the manual drive mode, the engine controller 130 can cause the drive motor 311 to rotate the photosensitive drum 11 in a state where the back cover 73 (opening/closing member) is at the open position and the transfer unit 7 is at the closed position (first position). As a case of rotationally driving the photosensitive drum 11 in the state where the transfer unit 7 is at the closed position, for example, the user may press the power button 80 with a cloth sandwiched in the transfer nip N1 to execute a rotation operation (SE4) of the photosensitive drum 11. As a result, it is possible to clean the surface of the photosensitive drum 11 without manually moving the cloth.

Needless to say, in the manual drive mode, the photosensitive drum 11 is rotatable in the state where the transfer unit 7 is at the open position. In other words, in the manual drive mode, the engine controller 130 can cause the drive motor 311 to rotate the photosensitive drum 11 in a state where the back cover 73 (opening/closing member) is at the open position and the transfer unit 7 is at the open position (second position).

Further, the manual drive mode in the present embodiment is a dedicated mode for the user to visually confirm the soiling and the toner lump adhering to the surface of the photosensitive drum 11. Therefore, the print job instruction is not received during the execution of the manual drive mode. Further, in the present embodiment, during the execution of the manual drive mode, the power button 80 is used as an instruction unit (operation unit) for giving an instruction on the rotation operation of the photosensitive drum 11. Therefore, during the execution of the manual drive mode, an operation (such as power OFF) when the power button 80 is pressed in the ready state is not performed.

Further, the engine controller 130 of the present embodiment receives a mode transition command from the video controller 140 with an operation on the driver screen as a trigger, and then enters the manual drive mode on the basis of opening of the back cover 73. If the engine controller 130 is configured to enter the manual drive mode only by the mode transition command as a comparative example, the user can open and close the back cover 73 during the execution of the manual drive mode. Then, of the back cover 73 is repeatedly opened and closed during the execution of the manual drive mode, there is a possibility that foreign matter such as dust or fluff adhering to the upper surface of the image forming apparatus 1, the conveyance path in the apparatus, or the like falls onto the photosensitive drum 11 due to vibration of the opening/closing. The foreign matter falling on the photosensitive drum 11 may damage the photosensitive drum 11 and other members to cause an image defect. Therefore, it is favorable that the back cover 73 is always open during the execution of the manual drive mode. In the present embodiment, since the manual drive mode is started on condition that the back cover 73 is moved from the closed position to the open position, it is possible to reduce the possibility of occurrence of image defects due to adhesion of foreign matter as described above.

Further, the procedure of giving an instruction on the transition to the manual drive mode by the operation on the driver screen and further opening the back cover 73 is a procedure different from a general print job transmission operation. Therefore, it is possible to reduce the possibility that the user mistakenly places the engine in the manual drive mode.

Note that the method of setting the engine controller 130 to the manual drive mode is not limited to the above-described method. For example, when the user operates a button or a switch (that may be a button or a switch on a screen displayed on the operation panel) provided in the image forming apparatus 1, the engine controller 130 may enter the manual drive mode. In this case, a mode transition command may be sent to the engine controller 130 with a user operation as a trigger without passing through the video controller 140, and the engine controller 130 may enter the manual drive mode.

Furthermore, in the present embodiment, an example has been described in which the power button 80 is used as an instruction unit (operation unit) for giving an instruction on the rotational driving of the photosensitive drum 11 in the manual drive mode, but the user may give an instruction on the rotational driving of the photosensitive drum 11 by using another unit. For example, in the manual drive mode, a dedicated button for giving the instruction on the rotational driving of the photosensitive drum 11 may be disposed on the operation panel of the image forming apparatus 1. Further, a button for giving the instruction on execution of the rotational driving of the photosensitive drum 11 may be displayed on the driver screen.

### Second Embodiment

Next, a second embodiment will be described. The second embodiment is different from the first embodiment in continuously and slowly rotationally driving a photosensitive drum 11 in a manual drive mode. As a result, a user can visually confirm how soiling on the photosensitive drum 11 is being cleaned by a cleaning unit 13. According to the present embodiment, it is possible to reduce user's time and effort of cleaning soiling on the photosensitive drum 11.

Hereinafter, elements denoted by reference numerals common to the first embodiment will have basically the same configurations and operations as those described in the first embodiment unless otherwise specified, and portions different from those of the first embodiment will be mainly described.

A procedure until an engine controller 130 enters the manual drive mode by opening a back cover 73 after the user selects the manual drive mode on a driver screen (SE3) is similar to that in the first embodiment (FIG. 10). When the user presses a power button 80 after the engine controller 130 enters the manual drive mode (SY4), rotational driving of the photosensitive drum 11 by a drive motor 311 is started (SE4A).

Here, in the present embodiment, the engine controller 130 causes the drive motor 311 to continuously rotate the photosensitive drum 11 at a low speed (SE4A). When the user presses the power button 80 again (SY5B) after the start of the rotational driving of the photosensitive drum 11, the engine controller 130 stops the drive motor 311 to stop the rotational driving of the photosensitive drum 11 (SE4B). That is, in the manual drive mode, the engine controller 130 continuously rotates the photosensitive drum 11 until an instruction on rotation stop of the photosensitive drum 11 is given.

As described above, by the continuous rotation of the photosensitive drum 11, soiling and a toner lump on the photosensitive drum 11 repeatedly pass through the cleaning unit 13 and are gradually cleaned, and eventually disappear. In particular, in a case where the soiling adhering to the photosensitive drum 11 has just adhered and is easily removed, the soiling is relatively quickly removed. The user visually observes a surface of the rotating photosensitive drum 11, and confirms that the soiling and the toner lump have disappeared (SY5A). According to the present embodiment, it is possible to reduce a burden on the user as compared with a case where the user himself/herself cleans the photosensitive drum 11.

A peripheral speed of the photosensitive drum 11 in the manual drive mode is desirably lower than a process speed at the time of image formation (the peripheral speed of the photosensitive drum 11 at the time of executing an image formation operation). Thereby, the user can easily visually check the presence or absence of the soiling on the photosensitive drum 11. However, if it is too slow, a time required for cleaning the soiling adhering to the photosensitive drum 11 by the cleaning unit 13 becomes long. In the present embodiment, a rotational speed (peripheral speed) of the photosensitive drum 11 in the manual drive mode is set to 15 mm/sec, which is lower than the process speed (93 mm/sec) when a print job is executed in a second mode corresponding to thick paper or the like.

Here, there may be a case where the soiling or the toner lump that does not disappear only by the rotational driving of the photosensitive drum 11 exists (SY6N), such as a case where a time has passed since the soiling has adhered onto the photosensitive drum 11 and the soiling has fixed. In this case, the user presses the power button 80 again after softening the soiling by adding moisture to the soiling with a cloth wetted with water or the like in a state where the photosensitive drum 11 is stopped (SY4A). As a result, the rotational driving of the photosensitive drum 11 is started again (SE4A), and the cleaning unit 13 can clean the soiling or the toner lump that has become soft. In addition, the user may clean the soiling or the toner lump by rubbing the surface of the photosensitive drum 11 with a cloth or the like in the state where the photosensitive drum 11 is stopped.

In SY6, in a case where it is sufficiently confirmed that no soiling and no toner lump adhere to the entire surface of the photosensitive drum 11 (SY6Y), the user changes the back cover 73 to a closed position (SY7). Accordingly, the engine controller 130 terminates the manual drive mode in a similar procedure to the first embodiment (SE5 and SE6).

As described above, an image forming apparatus 1 of the present embodiment can execute the manual drive mode as a mode of rotationally driving the photosensitive drum 11 in a state where a part of the surface of the photosensitive drum 11 is exposed to an outside of the image forming apparatus 1. Accordingly, the user can easily check the soiling on the surface of the photosensitive drum 11.

In addition, according to the present embodiment, since the photosensitive drum 11 is continuously rotationally driven in the manual drive mode, the user can check how the soiling on the photosensitive drum 11 is being cleaned by the cleaning unit 13. As a result, it is possible to reduce the time and effort for the user to perform cleaning by himself/herself.

In the present embodiment, every time the power button 80 is pressed in the manual drive mode, the rotational driving and the stop of the photosensitive drum 11 are switched. Alternatively, for example, in the manual drive mode, the rotational driving of the photosensitive drum 11 may be continued while the user presses the power button 80, and the rotational driving of the photosensitive drum 11 may be stopped when the user releases a hand from the power button 80. Alternatively, when the power button 80 is pressed once for a short time, the photosensitive drum 11 is rotationally driven by a predetermined amount as in the first embodiment and then stopped, and the rotational driving of the photosensitive drum 11 may be continued while the power button 80 is pressed for a long time.

### Third Embodiment

Next, a third embodiment will be described. In the third embodiment, a voltage is applied to a developing roller 12 when a manual drive mode is executed. As a result, a small amount of toner adheres to a surface of a photosensitive drum 11, and a user can easily visually recognize soiling.

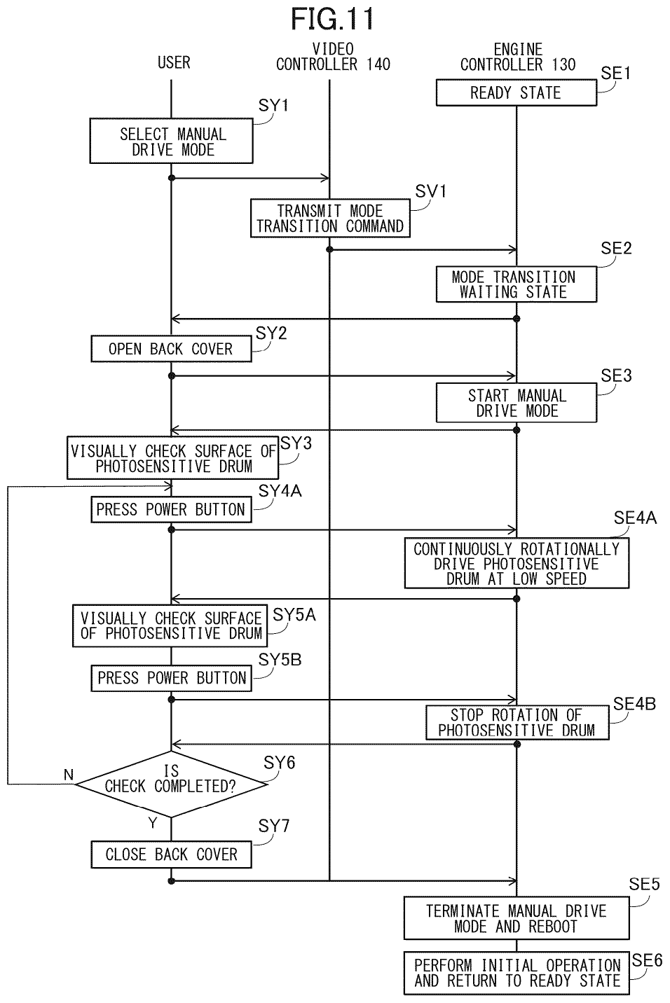

Hereinafter, elements denoted with the same reference numerals as those in the first embodiment are assumed to have basically the same configurations and operations as those described in the first embodiment unless otherwise specified, and portions different from those in the first embodiment will be mainly described. A sequence of the manual drive mode in the third embodiment is the same as the sequence (FIG. 11) described in the second embodiment except that the voltage is applied to the developing roller 12 when the photosensitive drum 11 is rotationally driven (SE4A in FIG. 11), and thus description thereof is omitted.

The voltage applied to the developing roller 12 in the manual drive mode will be described. FIG. 12A illustrates a relationship among a charging voltage Vpri1, a dark potential Vd1, a developing potential Vdc1, and a bright potential VII during execution of a normal print job (at the time of image formation). FIG. 12B illustrates a relationship between a surface potential Vext of the photosensitive drum 11 and a potential Vdc2 of the developing roller 12 at the time of execution of the manual drive mode.

The voltage is applied to the developing roller 12 in the manual drive mode over a period from when the drive motor 311 starts the rotational driving of the photosensitive drum 11 to when the photosensitive drum 11 finishes one rotation.

As illustrated in FIG. 12A, at the time of image formation, the charging voltage Vpri1 having a DC component of −800 V is applied to a charging roller 17 from a high-voltage power supply unit 120 (FIG. 3). As a result, for example, the surface of the photosensitive drum 11 is charged up to the dark potential Vd1 (=−500 V). The charged surface of the photosensitive drum 11 is exposed by laser beam irradiation from a scanner unit 50. As a result, the surface potential of an image region on the surface of the photosensitive drum 11 decreases to the bright potential Vl1 (=−100 V).

The developing voltage is applied to the developing roller 12. In the present embodiment, a jumping developing method in which the developing roller 12 is arranged in a non-contact manner with respect to the photosensitive drum 11 is adopted, and the developing voltage containing an AC component is applied to the developing roller 12. In the present embodiment, the developing voltage obtained by superimposing an AC component having a duty of 50%, a frequency of 3 kHz, and 1750 V (peak-to-peak voltage) on a DC component of −300 V is applied to form the developing potential Vdc1=−300 V

In a developing portion where the developing roller 12 and the photosensitive drum 11 face each other, a bias electric field is formed by a potential difference Vcont1 (developing contrast) between the developing potential Vdc1 and the bright potential Vl1 of the photosensitive drum 11. By this bias electric field, a toner borne on the developing roller 12 is transferred to an image region having the bright potential Vl1 on the photosensitive drum 11, and an electrostatic latent image is developed into a toner image. Therefore, the DC component (Vdc1) of the voltage applied to the developing roller 12 at the time of image formation is a voltage having the same polarity as a normal polarity of the toner with reference to the bright potential Vl1 of the photosensitive drum 11.

Next, setting of the voltage applied to the developing roller 12 in the manual drive mode will be described. In the manual drive mode, the back cover 73 and a transfer unit 7 are at an open position, and the photosensitive drum 11 is rotationally driven in a state where a part of the surface is exposed to an outside of an image forming apparatus 1. Further, in the manual drive mode, no voltage is applied to a charging roller 62. Therefore, the surface of the photosensitive drum 11 is exposed by external light (for example, light of indoor illumination). Therefore, the surface potential Vext of the photosensitive drum 11 during the execution of the manual drive mode becomes approximately 0 V.

In the present embodiment, the surface of the photosensitive drum 11 rotationally driven in the manual drive mode is exposed with external light, so that the surface potential Vext of the entire surface of the photosensitive drum 11 including a soiling adhering portion is set to approximately 0 V For example, in a case where light is emitted from the scanner unit 50, the time during which an arbitrary point on the photosensitive drum 11 receives the light from the scanner unit 50 is extremely short, and thus the potential of the soiling adhering portion may not be sufficiently lowered. In contrast, since the time during which an arbitrary point on the photosensitive drum 11 receives external light in the manual drive mode is long, an integrated value of a light amount increases, and the potential of the soiling adhering portion also decreases to approximately 0 V.

To transfer the toner on the developing roller 12 onto the photosensitive drum 11, the voltage containing the DC component having the same polarity as the normal polarity of the toner is applied to the developing roller 12 in the manual drive mode. A potential difference Vcont2 of the potential Vdc2 of the developing roller 12 with respect to the surface potential Vext of the photosensitive drum 11 is set to the voltage having the same polarity as the potential difference Vcont1 of the developing potential Vdc1 with respect to the bright potential Vii at the time of image formation. That is, an applied voltage is applied to the developing roller 12 such that the potential of the developing roller 12 becomes the predetermined potential difference Vcont2 with respect to the surface potential Vext of the photosensitive drum 11, which is approximately 0 V, at the time of execution of the manual drive mode. The predetermined potential difference Vcont2 is favorably smaller in absolute value than the potential difference Vcont1 at the time of image formation. That is, density of the toner transferred from the developing roller 12 to the surface of the photosensitive drum 11 by the potential difference Vcont2 is favorably lower than density of the toner in the image region at the time of image formation.

In the present embodiment, a voltage obtained by superimposing the AC component having the duty of 50%, the frequency of 3 kHz, and 1750 V (peak-to-peak voltage) on the DC component of −100 V is applied to the developing roller 12. As a result, −100 V was formed as the potential Vdc2 of the developing roller 12. A waveform of the AC component may be the same as a waveform of the AC component of the developing voltage at the time of image formation (for example, a rectangular wave).

As described above, in the manual drive mode, the potential difference Vcont2 of −100 V with respect to the surface potential Vext of the photosensitive drum 11 is generated by applying the voltage including the DC component of −100 V to the developing roller 12. In other words, the surface potential of the photosensitive drum 11 when the photosensitive drum 11 is rotated in the manual drive mode is set to Vm1, and the potential of the developing roller 12 when the photosensitive drum 11 is rotated in the manual drive mode is set to Vm2. In this case, in the manual drive mode, a voltage set so that a sign of the potential difference Vcont2 (=Vm2 −Vm1) matches the normal polarity of the toner is applied to the developing roller 12.

By the potential difference Vcont2, the toner on the developing roller 12 can be transferred to the photosensitive drum 11 in the manual drive mode. At this time, since the entire surface of the photosensitive drum 11 is lowered to the surface potential Vext (=0 V) for the above-described reason, a thin toner layer (halftone) is formed on the entire surface. The toner layer formed on a region other than the soiling adhering portion on the photosensitive drum 11 is removed when passing through a cleaning blade 13a (FIG. 2). However, in the toner layer formed on the soiling adhering portion on the photosensitive drum 11, the toner is not fully removed even if passing through the cleaning blade 13a due to an adherence property of the soiling, and the toner remains on the surface of the photosensitive drum 11. As a result, even in a case where the soiling on the photosensitive drum 11 is transparent and difficult to see, the toner can be attached to the soiling on the photosensitive drum 11 from the developing roller 12, and visibility of the soiling can be enhanced.

The user who has visually recognized the soiling on the photosensitive drum 11 presses, for example, the power button 80 to stop the rotation of the photosensitive drum 11 (SY5B and SE4B in FIG. 11), and can wipe off the soiling with a cloth or the like. In the present embodiment, since the visibility of the soiling in the manual drive mode can be enhanced, the user can stop the rotation of the photosensitive drum 11 at appropriate timing when the soiling adhering portion on the photosensitive drum 11 is exposed.

By the way, if the voltage is constantly applied to the developing roller 12 during the execution of the manual drive mode, there is a case where the toner adheres to the soiling too much and the toner lump becomes large. In the present embodiment, the voltage is applied to the developing roller 12 by the high-voltage power supply unit 120 only during a period from the start of rotation of the photosensitive drum 11 in the manual drive mode to the end of one rotation of the photosensitive drum 11 (until the surface of the photosensitive drum 11 moves by 75 mm). After the photosensitive drum 11 rotates once, the voltage application to the developing roller 12 is stopped.

Note that, in the present embodiment, since the voltage is applied to the developing roller 12 in a state where the back cover 73 and the transfer unit 7 are opened, it is desirable that the user does not directly touch the developing roller 12 during the voltage application. In particular, since the voltage containing the AC component is applied to the developing roller 12, it is favorable that the user cannot directly touch the developing roller 12. For example, when an image forming apparatus 1 is viewed from a back side in the state of FIG. 4C, it is favorable that the developing roller 12 and terminals for applying the voltage to the developing roller 12 and provided on an outer surface of a process unit 40 are not exposed. Alternatively, the voltage applied to the developing roller 12 in the manual drive mode may have a voltage value and an energy level at which there is no problem even if the user accidentally touches the developing roller.

As described above, the image forming apparatus 1 of the present embodiment can execute the manual drive mode as a mode of rotationally driving the photosensitive drum 11 in the state where a part of the surface of the photosensitive drum 11 is exposed to the outside of the image forming apparatus 1. Accordingly, the user can easily check the soiling on the surface of the photosensitive drum 11.

Further, according to the present embodiment, the toner is attached to the soiling by applying the voltage to the developing roller 12 in the manual drive mode. As a result, it is possible to more easily confirm the presence or absence of soiling on the photosensitive drum 11 that causes white spots.

### Fourth Embodiment

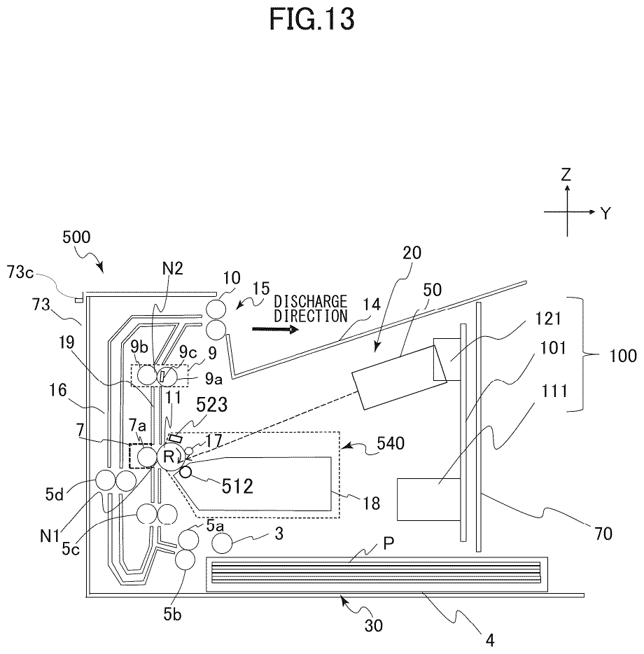

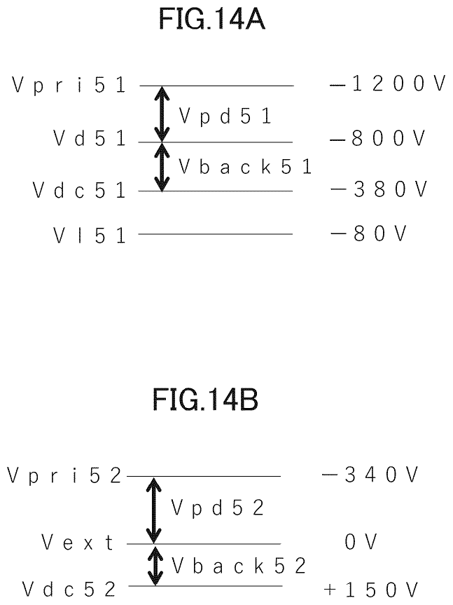

Next, a fourth embodiment will be described with reference to FIGS. 13, 14A, and 14B. In the fourth embodiment, a cleaner-less type image forming apparatus 500 having no cleaning unit for cleaning a surface of a photosensitive drum 11 will be described as an example. In addition, the image forming apparatus 500 is a separation-less contact development method in which the photosensitive drum 11 and a developing roller 512 are always in contact with each other in a developing portion. In a contact development method, a toner borne on the developing roller 512 comes into contact with the surface of the photosensitive drum 11 in the developing portion. In addition, there is a case where a separation mechanism that brings the developing roller 512 into contact with the photosensitive drum 11 and separates the developing roller 512 from the photosensitive drum 11 is provided in the contact development method, but in the present embodiment, the separation-less contact development method in which both always come into contact with each other is adopted.

Hereinafter, elements denoted with the same reference numerals as those in the first embodiment are assumed to have basically the same configurations and operations as those described in the first embodiment unless otherwise specified, and portions different from those in the first embodiment will be mainly described.

In the cleaner-less image forming apparatus 500, soiling adhering to the photosensitive drum 11 is less likely to disappear only by rotationally driving the photosensitive drum 11 in a manual drive mode.

Further, in the jumping developing method described in the first to third embodiments, there is a gap between the developing roller 512 and the photosensitive drum 11. Therefore, the toner adheres to a soiling adhering portion on the photosensitive drum 11 to form a toner lump in a case where the soiling adhering portion becomes an image region (exposure region) at the time of image formation. Meanwhile, in the contact development method, in a case where the soiling adheres to the photosensitive drum 11, the soiling adhering portion comes into contact with the toner on the developing roller 512 when passing through the developing portion regardless of whether the soiling adhering portion is an image region or a non-image region. Therefore, in the contact development method, the toner adheres to the soiling adhering portion on the photosensitive drum 11 and the toner lump is more likely to be generated than a case in the jumping development method.

That is, in the image forming apparatus 500 of the cleaner-less type and the separation-less development contact type, there is a case where white spots as illustrated in FIG. 8A are likely to occur.

Furthermore, in the separation-less contact development method, when the surface of the photosensitive drum 11 is exposed to an outside of the image forming apparatus 500 and a surface potential becomes approximately 0 V, the photosensitive drum 11 and the developing roller 512 come into contact with each other in a state where the potentials are equal to each other. Therefore, a part of the toner on the developing roller 512 is transferred to the photosensitive drum 11, and so-called fog (the toner thinly adheres to the entire surface of the photosensitive drum 11) occurs.

Therefore, in the image forming apparatus of the cleaner-less type and the separation-less development contact type, the fog is likely to occur even when the manual drive mode is executed, and the visibility of the toner lump on the photosensitive drum 11 may be low. Note that, in an image forming process, a part of the toner may be transferred from a process member (for example, a charging roller 17) acting on the photosensitive drum 11 to the photosensitive drum 11 to cause the fog.

Therefore, in the present embodiment, a configuration is proposed, which enables the entire surface of the photosensitive drum 11 to be visually confirmed more easily while improving visibility of the soiling and the toner lump adhering to the photosensitive drum 11.

FIG. 13 is a schematic view illustrating a cross section of the image forming apparatus 500 according to the present embodiment. The image forming apparatus 500 is different from the image forming apparatus 1 described in the first embodiment in including a pre-exposing unit 523 instead of a cleaning unit 13, and having a developing portion having a different configuration. Other configurations are the same as those of the image forming apparatus 1.

### Cleaner-Less Method

A process unit 540 of the present embodiment includes the pre-exposing unit 523. The pre-exposing unit 523 is disposed downstream of a transfer nip N1 and upstream of the charging portion in a rotation direction R of the photosensitive drum 11. The pre-exposing unit 523 irradiates a surface region of the photosensitive drum 11 after passing through the transfer nip N1 and before reaching the charging portion with light to remove electricity, thereby enabling stable discharge in the charging portion.

In the present embodiment, a contact development method is adopted as a development method. A toner layer borne on the developing roller 512 comes into contact with the photosensitive drum 11 at the developing portion where the photosensitive drum 11 and the developing roller 512 face each other. Note that a toner storage 18 may be provided with a supply roller that applies the toner as a stored developer to a surface of a developing roller 12.

A developing voltage is applied to the developing roller 512 by a high-voltage power supply unit 120. Under the developing voltage, the toner borne on the developing roller 512 is transferred from the developing roller 512 to a drum surface according to a potential distribution on the surface of the photosensitive drum 11. As a result, an electrostatic latent image on the photosensitive drum 11 is developed into a toner image.

As the toner of the present embodiment, a polymerization toner generated by a polymerization method was employed. A normal charging polarity (normal polarity) of the present toner is negative. Further, the present toner is a so-called non-magnetic one-component developer that does not contain a magnetic component and is borne on the developing roller 12 mainly by intermolecular force or electrostatic force (image force). However, a one-component developer containing a magnetic component may be used. Further, the one-component developer may contain additives (for example, wax or silica fine particles) for adjusting fluidity and charging performance of the toner in addition to toner particles.

Further, the image forming apparatus 500 according to the present embodiment is by a cleaner-less method. The toner (transfer residual toner) remaining on the photosensitive drum 11 without being transferred to a recording material at the transfer nip N1 is negatively charged by the charging roller 17 and reaches the developing portion. In the developing portion, at least a part of the transfer residual toner is collected into the toner storage 18 by the developing roller 12 due to a potential difference between the photosensitive drum 11 and the developing roller 12. More specifically, the transfer residual toner in the non-image region not irradiated with light from the scanner unit 50 is transferred from the photosensitive drum 11 to the developing roller 12 by the potential difference between a dark potential Vd1 and a developing potential Vdc1 at the time of image formation. Meanwhile, the transfer residual toner in the image region irradiated with light from the scanner unit 50 remains on the surface of the photosensitive drum 11 due to the potential difference between a bright potential Vl1 and the developing potential Vdc1 at the time of image formation, and becomes a part of the toner image.

In the cleaner-less method, since a container for collecting waste toner is not required, the image forming apparatus 500 can be downsized.

### Potential Setting in Manual Drive Mode

Also in the present embodiment, it is possible to execute the manual drive mode of rotationally driving the photosensitive drum 11 in a state where the surface of the photosensitive drum 11 is exposed to the outside of the image forming apparatus 500 by opening a back cover 73 and a transfer unit 7. Accordingly, a user can easily check the soiling on the surface of the photosensitive drum 11.

However, in the present embodiment, the fog may occur when the photosensitive drum 11 is rotationally driven in the state where the back cover 73 and the transfer unit 7 are opened, as described above. Therefore, in the present embodiment, in the manual drive mode, a voltage for reducing occurrence of the fog is applied to the process member in contact with the photosensitive drum 11. In the present embodiment, the “process member in contact with the photosensitive drum 11” includes the charging roller 17 and the developing roller 512.

FIG. 14A illustrates a potential relationship in the non-image region at the time of image formation. FIG. 14B illustrates the potential relationship in the non-image region at the time of execution of the manual drive mode.

As illustrated in FIG. 14A, at the time of image formation, a DC voltage of −1350 V is applied from the high-voltage power supply unit 120 to the charging roller 17 as a charging voltage Vpri51. As a result, for example, the surface potential of the photosensitive drum 11 is charged to Vd51=−800 V. In the present embodiment, a DC voltage of Vdc51=−380 V is applied to the developing roller 512. Further, a surface potential (bright potential Vl51) after exposure by the scanner unit 50 is −80 V.

The surface potential of the non-image region not exposed by the scanner unit 50 remains at the dark potential Vd51. Therefore, in the developing portion, a potential difference Vback51 (=Vd51−Vdc51) is formed between the developing roller 12 and the non-image region of the photosensitive drum 11. Since the potential difference Vback51 has an action of preventing transfer of the toner borne on the developing roller 12 to the photosensitive drum 11, it is also called fog removal contrast.

In addition, the charging roller 17 may hold the transfer residual toner transferred from the photosensitive drum 11 to the charging roller 17. The transfer residual toner contains toner particles (inverted toner) discharged at the transfer nip N1 and charged to a non-normal polarity (positive polarity), and toner particles (low charged toner) whose charge amount is close to 0. The inverted toner and the low charged toner are easily attracted to the charging roller 17 to which the charging voltage Vpri51=−1350 V is applied and held by the charging roller 17.

Further, in the present embodiment, since the cleaner-less method is adopted, the transfer residual toner generated at the transfer nip N1 reaches the charging portion without being removed by the cleaning unit. Therefore, as compared with an image forming apparatus including a cleaning unit, the amount of the transfer residual toner held by the charging roller 17 may easily increase.

The charging voltage Vpri51 applied to the charging roller 17 at the time of image formation is set to a voltage value further negative than the dark potential Vd51 of the photosensitive drum 11. Due to the potential difference Vpd51 between the charging voltage Vpri51 and the dark potential Vd51, a state in which the transfer residual toner (inverted toner and low charged toner) held by the charging roller 17 is less easily transferred from the charging roller 17 to the photosensitive drum 11 is maintained.

As illustrated in FIG. 14B, since the photosensitive drum 11 is exposed to the light outside the apparatus during the execution of the manual drive mode, the surface potential Vext of the photosensitive drum 11 is approximately 0 V Hereinafter, the description will be given assuming that Vext=0 V, but Vext does not need to be strictly 0 V.

To prevent transfer of the toner on the developing roller 512 to the photosensitive drum 11 in the manual drive mode, a potential difference Vback52 similar to the potential difference Vback51 at the time of image formation is formed between the developing roller 512 and the photosensitive drum 11. A voltage Vdc52 containing a DC component having a polarity opposite to the normal polarity of the toner may be applied to the developing roller 512. That is, the voltage applied to the developing roller 512 at the time of execution of the manual drive mode is set such that the potential (Vdc52) of the developing roller 512 and the surface potential Vext=0 V of the photosensitive drum 11 have a predetermined potential difference Vcont2.

In the present embodiment, during the execution of the manual drive mode, a DC voltage of +150 V is applied to the developing roller 512 as the voltage Vdc52.

Further, to prevent transfer of the transfer residual toner on the charging roller 17 to the photosensitive drum 11 in the manual drive mode, a potential difference Vpd52 similar to the potential difference Vpd51 at the time of image formation is formed between the charging roller 17 and the photosensitive drum 11. A voltage Vpri52 containing a DC component having the same polarity as the normal polarity of the toner may be applied to the charging roller 17. That is, the voltage Vpri52 applied to the charging roller 17 at the time of execution of the manual drive mode is set such that the potential of the charging roller 17 and the surface potential Vext=0 V of the photosensitive drum 11 have the predetermined potential difference Vpd52.

In the present embodiment, during the execution of the manual drive mode, a DC voltage of −340 V, which is a potential difference that does not discharge with respect to the surface potential Vext of the photosensitive drum 11, is applied as the voltage Vpri52 to the charging roller 17.

In other words, the surface potential of the non-image region of the photosensitive drum 11 at the time of image formation is set to Vg1, and the potential of the process member at the time of image formation is set to Vg2. Further, the surface potential of the photosensitive drum 11 when the photosensitive drum 11 is rotated in the manual drive mode is set to Vm1, and the potential of the process member when the photosensitive drum 11 is rotated in the manual drive mode is set to Vm2. In this case, in the manual drive mode, a voltage set so that the sign of the potential difference (Vg2−Vg1) matches the sign of the potential difference (Vm2−Vm1) is applied to the process member. As a result, it is possible to suppress the transfer of the toner held by the process member to the photosensitive drum 11 during the execution of the manual drive mode, and it is possible to improve the visibility of the soiling and the toner lump adhering to the photosensitive drum 11.

Specifically, the voltage is applied to the developing roller 512 during the execution of the manual drive mode such that the polarity of the potential of the developing roller 512 based on the surface potential of the non-image region of the photosensitive drum 11 during the image formation is the same as the polarity of the potential of the developing roller 512 based on the surface potential of the photosensitive drum 11 during the execution of the manual drive mode. As a result, it is possible to suppress the transfer of the toner from the developing roller 512 to the photosensitive drum 11, and it is possible to improve the visibility of the soiling and the toner lump adhering to the photosensitive drum 11. In particular, in the present embodiment, it is possible to suppress the transfer of the toner from the developing roller 512 to the photosensitive drum 11 during the execution of the manual drive mode while adopting the separation-less contact development method in which the toner on the developing roller 512 is constantly in contact with the photosensitive drum 11.

In addition, the voltage is applied to the charging roller 17 during the execution of the manual drive mode such that the polarity of the potential of the charging roller 17 based on the surface potential of the non-image region of the photosensitive drum 11 at the time of image formation becomes the same as the polarity of the potential of the charging roller 17 based on the surface potential of the photosensitive drum 11 during the execution of the manual drive mode. As a result, it is possible to suppress the transfer of the toner from the charging roller 17 to the photosensitive drum 11 during the execution of the manual drive mode, and it is possible to improve the visibility of the soiling and the toner lump adhering to the photosensitive drum 11. In particular, in the present embodiment, it is possible to suppress the transfer of the toner from the charging roller 17 to the photosensitive drum 11 during the execution of the manual drive mode even in the cleaner-less method in which the transfer residual toner easily reaches the charging roller 17.

Note that, in the present embodiment, the developing roller 512 and the charging roller 17 have been exemplified as examples of the process member in contact with the photosensitive drum 11, but the voltage may be applied to another process member in contact with the photosensitive drum 11 during the execution of the manual drive mode.

In the present embodiment, it is favorable that a period during which the voltage is applied to the developing roller 512 and the charging roller 17 during the execution of the manual drive mode is only during rotational drive of the photosensitive drum 11.

Further, in the present embodiment, since the voltage is applied to the developing roller 512 and the charging roller 17 in the state where the back cover 73 and the transfer unit 7 are opened, it is desirable that the user does not directly touch the developing roller 512 or the charging roller 17 during the voltage application. For example, when the image forming apparatus 1 is viewed from the back side in the state of FIG. 4C, it is favorable that the developing roller 512 and the charging roller 17, and terminals for applying the voltage to the developing roller 512 and the charging roller 17 and provided on an outer surface of a process unit 40 are not exposed. Alternatively, the voltage applied to the developing roller 512 and the charging roller 17 in the manual drive mode may have a voltage value and an energy level at which there is no problem even if the user accidentally touches the developing roller or the charging roller.

Further, in the present embodiment, setting of the voltage applied to the charging roller 17 and the developing roller 512 has been described on the assumption that the surface potential Vext of the photosensitive drum 11 is approximately 0 V in the state where the back cover 73 and the transfer unit 7 are opened. Not limited to this example, for example, a configuration is conceived in which the photosensitive drum 11 is shielded from light at least in a range from the charging portion to the developing portion in the state where the back cover 73 and the transfer unit 7 are opened. In this case, even in the manual drive mode, the voltage may be applied to the charging roller 17 and the developing roller 512 with the same voltage setting as at the time of image formation.

As described above, according to the present embodiment, in the cleaner-less image forming apparatus 500 in which white spots are likely to occur, it is easy to check the presence or absence of soiling on the photosensitive drum 11 by the rotational driving of the photosensitive drum 11 while suppressing the fog in the manual drive mode.

### Other Modes

In each of the above-described embodiments, the case in which the image bearing member is the photosensitive drum has been exemplified, but the image bearing member may be an intermediate transfer member in an intermediate transfer-type image forming apparatus. The intermediate transfer member is, for example, an intermediate transfer belt used in a tandem color image forming apparatus. In this case, the toner image formed on the photosensitive drum included in each of a plurality of process units is primarily transferred to the intermediate transfer belt, and then secondarily transferred from the intermediate transfer belt to the recording material in a secondary transfer portion.

Further, in each of the above-described embodiments, the configuration in which a part of the surface of the photosensitive drum 11 is exposed to the outside of the image forming apparatus 1 when both the back cover 73 and the transfer unit 7 are opened has been exemplified. The present disclosure is not limited thereto, and the image forming apparatus 1 may include, for example, a unit (for example, a configuration in which the back cover 73 and the transfer unit 7 are integrated) including an outer surface forming the exterior surface of the image forming apparatus 1 and the transfer roller 7a serving as a transfer member. In this case, by moving the above-described unit from the closed position where the unit covers the opening portion 91 of the casing 72 to the open position where the unit opens the opening portion 91, it is possible to expose a part of the surface of the photosensitive drum 11 to the outside of the image forming apparatus 1.

Further, in each of the above-described embodiments, the image forming apparatus having a so-called C-path configuration in which the conveyance path of the recording material P inside the image forming apparatus is substantially C-shaped has been exemplified. The substantially C-shaped conveyance path is a path in which the recording material P is fed to one side (−Y side) in the horizontal direction, an image is formed while the recording material P is conveyed upward inside the apparatus, and the recording material P is discharged toward the other side (+Y side) in the horizontal direction. In the image forming apparatus having the C-pass configuration, the image bearing member is often exposed to the outside of the image forming apparatus by opening the back cover 73 and/or the transfer unit 7.

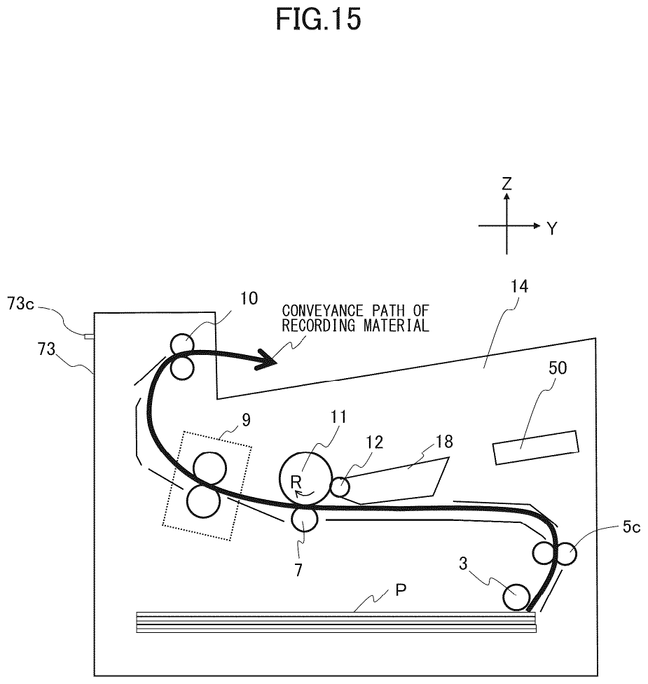

However, the configuration from which advantages of the present technology are obtained is not limited to the C-path configuration. For example, as illustrated in FIG. 15, the present technology may be applied to an image forming apparatus having a so-called S-pass configuration in which the conveyance path of the recording material P inside the image forming apparatus has a substantially S-shape. The substantially S-shaped conveyance path is a path in which the recording material P is fed to one side (−Y side) in the horizontal direction, an image is formed while the recording material P is conveyed toward the other side (+Y side) in the horizontal direction inside the apparatus, and the recording material P is discharged toward the one side (−Y side) in the horizontal direction.

In the configuration illustrated in FIG. 15, for example, the photosensitive drum 11 serving as an image bearing member may be exposed to the outside of the image forming apparatus by detaching the fixing unit 9 from the casing of the image forming apparatus. The attachable/detachable fixing unit 9 is an example of a unit detachably attached to the casing. Further, the state in which the fixing unit 9 is attached corresponds to the first state, and the state in which the fixing unit 9 is detached corresponds to the second state. Even in this case, by adopting a configuration capable of executing the manual drive mode in which the photosensitive drum 11 is rotationally driven in the state where a part of the surface of the photosensitive drum 11 is exposed to the outside of the apparatus, it is possible to obtain advantages similar to above-described embodiments.

The operation timing of rotation and stop of the image bearing member (photosensitive drum), the rotation amount, the rotational speed, the potential setting of each member, and the like in the manual drive mode described in each of the above-described embodiments are merely examples, and can be appropriately changed according to a specific configuration and operation conditions of the image forming apparatus.

In each of the above-described embodiments, the configuration in which the fixing film 9a and the pressure roller 9b are used as a pair of rotary members of the fixing unit 9, and the fixing film 9a is not rotationally driven in the manual drive mode has been exemplified. The configuration of the fixing unit 9 is not limited thereto, and for example, a pair of rollers including two cylindrical rollers may be used as the pair of rotary members. Further, the present disclosure is not limited to the configuration in which the fixing film 9a is not rotationally driven by the pressure roller 9b being separated from the fixing film 9a in the manual drive mode, and it is sufficient that the drive force of the drive source is not transmitted to at least one rotary member of the pair of rotary members.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-029873, filed Feb. 29, 2024, which is hereby incorporated by reference herein in its entirety.

What is claimed is:

1. An image forming apparatus comprising:
an image bearing member configured to rotate;
a unit capable of taking a first state in which a part of a surface of the image bearing member is allowed to be exposed to an outside of the image forming apparatus, and a second state in which the surface of the image bearing member is not exposed to the outside of the image forming apparatus;
a drive source configured to drive the image bearing member; and
a control unit configured to control the drive source, the control unit being configured to execute a mode in which the image bearing member is rotated by the drive source while the unit is in the first state.

2. The image forming apparatus according to claim 1, wherein,
in the mode, after the control unit causes the drive source to start the rotation of the image bearing member in a state where a first area of the surface of the image bearing member is exposed to the outside of the image forming apparatus, the control unit is configured to stop the rotation of the image bearing member in a state where a second area of the surface of the image bearing member different from the first area is exposed to the outside of the image forming apparatus.

3. The image forming apparatus according to claim 2, wherein
a part of the first area overlaps the second area.

4. The image forming apparatus according to claim 2, further comprising:
an operation unit configured to receive an operation of a user, wherein,
in the mode, the control unit is configured to execute a unit operation to rotate the image bearing member by a predetermined amount and then stop the rotation of the image bearing member each time the operation unit is operated.

5. The image forming apparatus according to claim 1, further comprising:
a cleaning unit configured to clean the surface of the image bearing member, wherein,
in the mode, the control unit is configured to continuously rotate the image bearing member until an instruction to stop the rotation of the image bearing member is given.

6. The image forming apparatus according to claim 5, wherein
a peripheral speed of the image bearing member in the mode is lower than a peripheral speed of the image bearing member in a case where the image forming apparatus executes an image formation operation using the image bearing member.

7. The image forming apparatus according to claim 1, wherein
the image bearing member is a photosensitive drum, and
the image forming apparatus further comprises a developing roller configured to supply toner to the photosensitive drum to develop a latent image into a toner image, and
in a case where a surface potential of the photosensitive drum in a case where the photosensitive drum is rotated in the mode is Vm1, and a potential of the developing roller in a case where the photosensitive drum is rotated in the mode is Vm2, a voltage set so that a sign of a potential difference (Vm2−Vm1) matches a normal polarity of the toner is applied to the developing roller in the mode.

8. The image forming apparatus according to claim 1, further comprising:
a process member configured to act on the image bearing member in an image forming process, wherein
in a case where a surface potential of a non-image region of the image bearing member at time of image formation is Vg1, a potential of the process member at the time of image formation is Vg2, a surface potential of the image bearing member in a case where the image bearing member is rotated in the mode is Vm1, and a potential of the process member in the case where the image bearing member is rotated in the mode is Vm2, a voltage set so that a sign of a potential difference (Vg2−Vg1) matches a sign of a potential difference (Vm2−Vm1) is applied to the process member in the mode.

9. The image forming apparatus according to claim 8, wherein
the image bearing member is a photosensitive drum, and
the process member is a charging roller that is brought into contact with the photosensitive drum and configured to charge a surface of the photosensitive drum.

10. The image forming apparatus according to claim 9, further comprising:
a developing roller configured to supply toner to the photosensitive drum to develop a latent image into a toner image; and
a toner storage configured to store the toner supplied to the developing roller, wherein
the image forming apparatus does not include a cleaning unit for removing, from the photosensitive drum, a residual toner that has not been transferred from the photosensitive drum to a member to be transferred, and is configured to collect at least a part of the residual toner to the toner storage by the developing roller.

11. The image forming apparatus according to claim 8, wherein
the image bearing member is a photosensitive drum, and
the process member is a developing roller configured to supply toner to the photosensitive drum to develop a latent image into a toner image, and is configured such that the toner borne on an outer peripheral surface of the developing roller is always in contact with a surface of the photosensitive drum.

12. The image forming apparatus according to claim 1, further comprising:
a casing having an opening portion, wherein
the unit is an opening/closing member movable between an open position where the opening portion is opened and a closed position where the opening portion is closed,
the first state is a state in which the unit is at the open position, and the second state is a state in which the unit is at the closed position, and
in a case where the opening/closing member is at the open position, the part of the surface of the image bearing member is allowed to be exposed to the outside of the image forming apparatus through the opening portion.

13. The image forming apparatus according to claim 12, further comprising:
a transfer unit having a transfer member, wherein
the transfer unit is movable to a first position where a transfer portion where a toner image is transferred from the image bearing member to a member to be transferred is formed between the transfer member and the image bearing member and to a second position where the transfer member is separated from the image bearing member, and
the part of the surface of the image bearing member is exposed to the outside of the image forming apparatus through the opening portion in a state where the opening/closing member is at the open position and the transfer unit is at the second position.

14. The image forming apparatus according to claim 13, wherein
in the mode, the control unit is configured to cause the drive source to rotate the image bearing member in a state where the opening/closing member is at the open position and the transfer unit is at the first position.

15. The image forming apparatus according to claim 13, wherein
in the mode, the control unit is configured to cause the drive source to rotate the image bearing member in a state where the opening/closing member is at the open position and the transfer unit is at the second position.

16. The image forming apparatus according to claim 13, further comprising:
a detection unit configured to output a detection signal according to whether or not the opening/closing member is at the closed position, wherein
the control unit is configured to, after an instruction on transfer to the mode is given from a user, start the mode in a case where the control unit detects that the opening/closing member is moved from the closed position to the open position on a basis of the detection signal of the detection unit.

17. The image forming apparatus according to claim 1, wherein
the unit includes an outer surface that forms an exterior surface of the image forming apparatus, and a transfer member that forms a transfer portion between the transfer member and the image bearing member.

18. The image forming apparatus according to claim 1, further comprising:
a casing to which the unit is detachably attached, wherein
the first state is a state in which the unit is attached to the casing, and
the second state is a state in which the unit is detached from the casing.

19. The image forming apparatus according to claim 1, further comprising:
a fixing unit that includes a pair of rotary members configured to rotate and that is configured to fix a toner image on a recording material while nipping and conveying the recording material at a nip portion of the pair of rotary members, wherein
the drive source is configured to rotationally drive the pair of rotary members, and
at least one rotary member of the pair of rotary members is configured not to be rotationally driven by the drive source during execution of the mode.

20. The image forming apparatus according to claim 1, wherein
the image bearing member is a photosensitive drum.

21. The image forming apparatus according to claim 1, wherein
the image bearing member is an intermediate transfer member, and
the image forming apparatus is configured to transfer a toner image from a photosensitive drum to the intermediate transfer member, and then transfer the toner image from the intermediate transfer member to a recording material.
